(19) United States
(12) Patent Application Publication
(10) Pub. No.: US 2026/0310938 A1
(43) Pub. Date: Oct. 8, 2026

(54) PARALLEL PROCESSING FOR FINE-TUNED MODEL GENERATIVE RESPONSE MODELS AND THE MEMORY MANAGEMENT THEREOF

(71) Applicant: OpenAI OpCo, LLC, San Francisco, CA (US)

(72) Inventors: John Allard, San Francisco, CA (US); James Blomo, San Francisco, CA (US); Stanley Hsieh, San Francisco, CA (US); Xinran Dong, San Francisco, CA (US)

(73) Assignee: OpenAI OpCo, LLC, San Francisco, CA (US)

(21) Appl. No.: 19/170,532

(22) Filed: Apr. 4, 2025

(51) Int. Cl. G06N 3/0455

(52) U.S. Cl. CPC G06N 3/0455

(57) ABSTRACT

The present technology pertains to a generative response system (“system”) that includes generative inference engines (“engines”) on each of which multiple fine-tuned models can be simultaneously loaded. A controller determines the order in which requests for respective fine-tuned models are queued/batched. Requests for currently loaded models (e.g., models currently on an engine) are processed first. Requests for a model that is not currently loaded are processed after swapping the model onto an engine, according to a caching hierarchy, to replace a long-dormant (or infrequently used) model. After being swapped off the inference engine, a system copy of the long-dormant model is maintained in system memory (e.g., CPU RAM) for easy retrieval in case the model is subsequently requested. After not being requested for an extended time, the system copy of the long-dormant model is removed and only a network copy is maintained in network storage.

### BACKGROUND

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation. Generative response engines can sift through vast amounts of text data, extract context, and provide coherent responses to a wide array of queries.

A new direction for generative response engines is to fine-tune a base model for particular tasks using a specialized training set.

For example, fine-tuned adapters can be added to a base model for efficiently adapting large pre-trained models to specific tasks without retraining the entire model. These adapters are small, task-specific modules inserted into pre-trained networks, allowing for parameter-efficient fine-tuning. Low-rank adapters (LoRA) represent one such approach where only a low-rank decomposition of weight matrices is updated, resulting in reduced computational requirements and memory usage relative to full fine-tuning (also referred to as end-to-end fine-tuning). LoRA can improve model performance for various downstream tasks without the need for full retraining, making it particularly useful in resource-constrained settings.

For example, Y. Sheng et al., “S-LoRA: Serving Thousands of Concurrent Lora Adapters” arXiv:2311.03285.v3 [cs.LG], available at https://arxiv.org/abs/2311.03285 describes a Scalable LoRA (S-LoRA) extension that builds on the original LoRA approach by enhancing its flexibility and efficiency for large-scale models. S-LoRA provides a system that serves numerous Low-Rank Adaptation (LoRA) adapters concurrently. The S-LoRA uses a tensor parallelism strategy and optimized custom CUDA kernels for heterogeneous batching of LoRA computations to serve many adapters on a single GPU.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1A illustrates a block diagram of an example of a generative response system for simultaneously processing requests for disparate fine-tuned models in accordance with some embodiments of the present technology.

FIG. 1B illustrates a block diagram of an example of the generative response system of FIG. 1A after the request have been queued at respective inference engines of the generative response system in accordance with some embodiments of the present technology.

FIGS. 2A-2D illustrate block diagrams of an example of the generative response system that includes inference clusters having respective inference engines that use a common base model in accordance with some embodiments of the present technology.

FIG. 3 illustrates a block diagram of an example of a generative response system having a caching hierarchy including memories on the respective inference engines, system memories on the generative response system, and a network storage in accordance with some embodiments of the present technology.

FIG. 4 illustrates a flow diagram of an example of a method for implementing some embodiments of the present technology.

FIG. 5A illustrates a block diagram of an example of a pretrained layer of an ML model in accordance with some embodiments of the present technology.

FIG. 5B illustrates a block diagram of an example of a fine-tuned model in accordance with some embodiments of the present technology.

FIG. 6 illustrates an example system supporting a generative response engine during inference operations in accordance with some embodiments of the present technology.

FIG. 7 is a block diagram illustrating an example ML platform for implementing various aspects of this disclosure in accordance with some aspects of the present technology.

FIGS. 8A-8C illustrates an example transformer architecture in accordance with some embodiments of the present technology.

FIG. 9 shows an example of a computing system for implementing some embodiments of the present technology.

### DETAILED DESCRIPTION

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation. However, despite their remarkable linguistic prowess, these generative response engines operate on a foundation of publicly available information and do not possess personal information about individual users.

Many generative response engines provide a conversational user interface powered by a chatbot whereby the user account interacts with the generative response engine through natural language conversation with the chatbot. Such a user interface provides an intuitive format to provide prompts or instructions to the generative response engine.

When providing fine-tuned versions of generative response engines for individual customers, efficient resource management can be challenging. Each fine-tuned model version depends on specialized handling within the GPUs, and handling numerous models simultaneously can lead to excessive overhead and inefficiency due to the need to swap a large number of weights in and out of GPU memory for each unique customer model. As customer requests arrive sporadically, maintaining efficient use of GPU resources becomes challenging, potentially leading to underutilized GPUs or excessive computational load, if not managed properly. Without an efficient solution, the cost and complexity of providing scalable, on-demand fine-tuned models for different customers can become prohibitive.

However, generative response engines can be improved to increase processing efficiency and minimize latency when generating responses in parallel using multiple fine-tuned models (e.g., low-rank adaptation (LoRA) models). These improvements can include: (1) batching and requests for the same fine-tuned model to run in parallel, even when received at different times; (2) storing multiple fine-tuned models on the generative response engine to minimize swapping among the fine-tuned models; (3) providing a caching hierarchy and decision rules for efficiently loading requested fine-tuned models onto the generative response engine and removing dormant fine-tuned models from the generative response engine.

According to certain non-limiting examples, the systems and methods disclosed herein can provide an optimized system for dynamically managing fine-tuned model components (e.g., low-rank adaptation (LoRA) layers,) which serve as small, customer-specific adapters that adjust the outputs of a base model. Instead of loading entire models into the GPU, this system enables only the small, fine-tuned LoRA layers to be loaded or swapped dynamically. The system further optimizes efficiency by:
Directing incoming requests to inference clusters where the required LoRA adapter is already in memory, minimizing swap time;
Holding specific adapters in GPU memory if the incoming request frequency is high, effectively “pinning” them to reduce the need for repeated swapping; and
Routing requests intelligently to fully utilize GPU resources within clusters, ensuring high efficiency without requiring additional model loading and unloading overhead.

This approach balances computational efficiency and adaptability by managing fine-tuned layers at a lower resource cost, allowing support for numerous customer-specific models without sacrificing GPU performance or cost efficiency.

According to certain non-limiting examples, the systems and methods disclosed herein provide a generative response system (“system”) that includes generative inference engines, and multiple fine-tuned models can be simultaneously loaded on each of the inference engines. A controller determines the order in which requests for respective fine-tuned models are queued and/or batched. The requests for currently loaded models (e.g., models currently on at least one of inference engines) are processed first. The requests for a model that is not currently loaded are processed after swapping the model onto one of the inference engines, according to a caching hierarchy. The model can be swapped onto the inference engine to replace a long-dormant or infrequently used model. The caching hierarchy can include that after swapping out a model from the inference engine, a system copy of the model is maintained in system memory (e.g., CPU RAM) for easy retrieval in case the model is subsequently requested. After not being requested for an extended time, the system copy of the model can be removed and a network copy maintained in network storage.

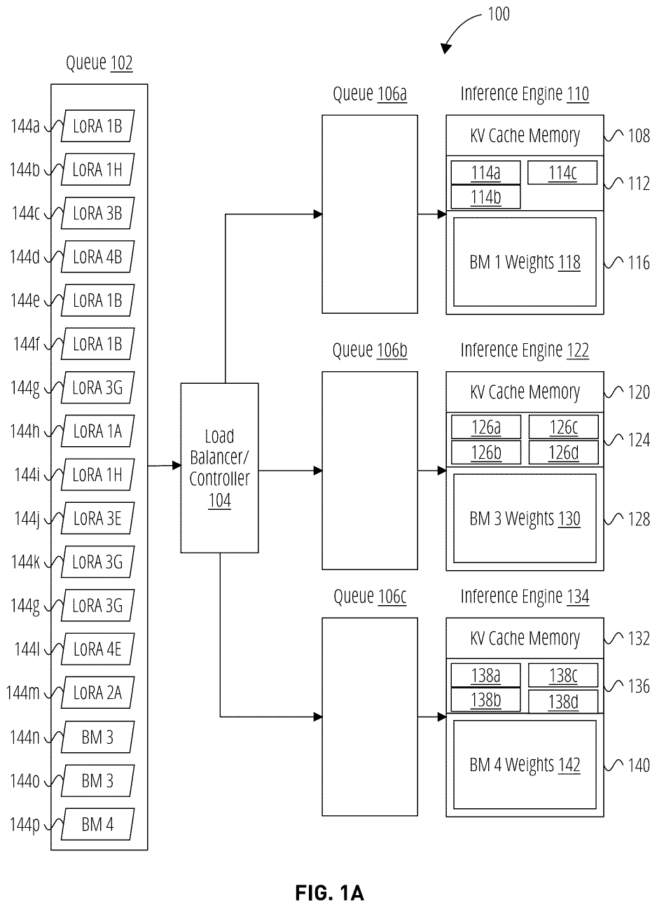

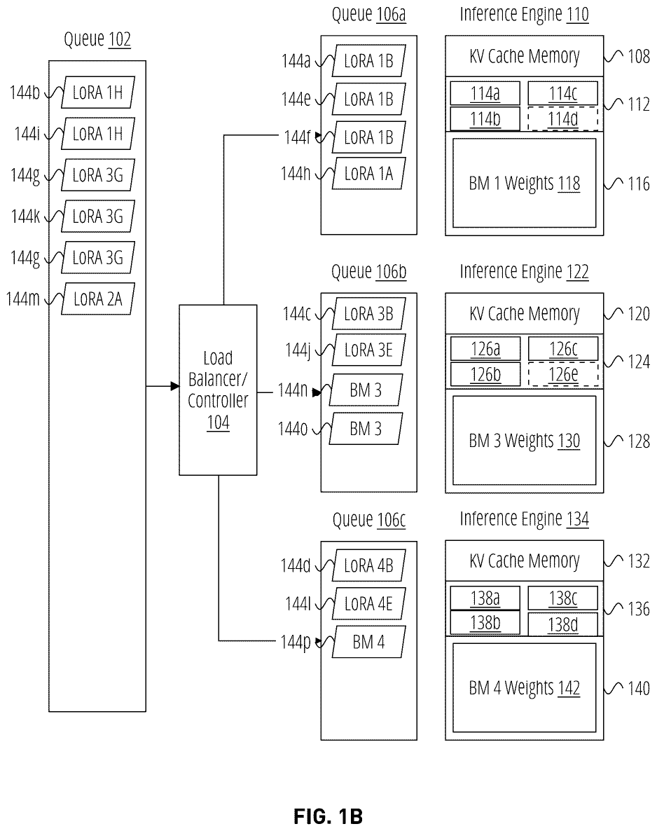

FIG. 1A illustrates an example of system 100 that performs low order rank (LoRA) based routing. System 100 includes multiple inference engines (e.g., inference engine 110, inference engine 122, and inference engine 134) that are each a generative response engine that receives a prompt/request and generates an output/response that is inferred from the prompt/request. For example, the inference engines can be large language models (LLMs) such as generative pre-trained transformers (GPTs), generative transformers, and multi-modal generative transformers. Further, the inference engines can include a base model (BM) or machine learning (ML) model that has been fine-tuned for a particular application. Here, the concept of fine-tuned models is illustrated using the non-limiting example of LoRA fine-tuning, but a person of ordinary skill in the art will recognize that other fine-tuning techniques can be used.

As discussed below, the fine-tuned model includes a first set of weights for the base model (e.g., BM weights) and a second set of weights of the fine-tuned model (e.g., the LoRA weights). The number of BM weights can be significantly larger than the number of LoRA weights, and an inference engine can be loaded with many more sets of LoRA weights than BM weights. In the example shown in FIG. 1A, each inference engine is illustrated as having memory dedicated for three purposes: (1) key value (KV) cache memory; (2) LoRA weights; and (3) BM weights. In this non-limiting example, each inference engine is illustrated as storing BM weights for a single BM and storing LoRA weights for up to four LoRA fine-tuned models. Each LoRA model is generated based on a particular BM. For example, LoRA 1A 114a is a LoRA that is labeled by the designation “1A,” which means that LoRA 1A 114a is the LoRA model with the label “A” that is based on the base model BM #1.

Similarly, LoRA 1B 114b is the LoRA model with the label “B” LoRA that is based on the base model BM #1; LoRA 3C 126b is the LoRA model with the label “C” LoRA that is based on the base model BM #3; and so forth. Each LoRA model is loaded on an inference engine on which the corresponding base model is loaded. For example, LoRA models labeled with the number “1” are loaded on the inference engines that also store BM weights for BM #1.

A single inference engine can run a system that includes multiple graphics processing units (GPUs) and/or multiple central processing units (CPUs). For example, an LLM such as GPT-3 can use multiple GPUs due to the size of the model of the model exceeding the memory capacity of a single GPU. To illustrate, GPT-3 has about 175 billion parameters, which uses around 350-GB of memory to store the model weights. Often high-performance GPUs (e.g., the NVIDIA A 100™ series GPUs) can have 40-GB or 80-GB of memory. For 80-GB GPUs, such as the NVIDIA A100s™, five or more GPUs would be sufficient to store the entire model (e.g., 80-GB per GPU times five GPUs provides 400-GB, which is greater than the 350-GB occupied by the GPT-3 base model).

By increasing the number of 80-GB GPUs to seven, the combined amount of memory on the GPUs becomes 560-GB, of which 350-GB can be dedicated to storing the BM weights, 110-GB can be allocated to storing the LoRA weights, and 100-GB can be dedicated to KV cache. The number of weights for (and memory used by) a LoRA model can be more than a thousand times smaller than for the base model. Thus, 110-GB of the total GPU memory can be used to store the weights for hundreds of LoRA models (e.g., 500 LoRA models). Further, 100-GB of memory for KV cache can be sufficient to run multiple queries in parallel. Assuming that about 2.5-GB of KV cache is needed for a single query with 1,024 tokens, 100-GB of KV cache is sufficient to run 40 queries in parallel. This example is non-limiting and is provided to illustrate how the number of LoRA models and the number of parallel queries can scale based on the amount of memory allocated to KV cache and allocated to storing LoRA weights. Like the BM weights, the LoRA weights for a given model are distributed among the GPUs. As discussed below, the LoRA weights can correspond to respective layers in a neural network. Thus, the LoRA weights for a given layer can be in the same GPU as the BM weights for that layer.

In FIG. 1A, inference engine 110 includes a memory storage that is subdivided into KV cache memory 108, LoRA weights memory 112, and base model weights memory 116.

LoRA weights memory 112 is illustrated as accommodating up to four LoRA models, with only three of the four available LoRA openings occupied by the following LoRA models: LoRA 1A 114a, LoRA 1B 114b, and LoRA 1C 114c. Base model weights memory 116 is occupied by BM 1 weights 118.

The memory storage of inference engine 122 is subdivided into KV cache memory 120, LoRA weights memory 124, and base model LoRA weights memory 124. In FIG. 1A, LoRA weights memory 124 is illustrated as being occupied by the following LoRA models: LoRA 3B 126a, LoRA 3C 126b, LoRA 3E 126c, and LoRA 3K 126d. Base model weights memory 116 is illustrated as being occupied by BM 3 weights 130. Here, all the LoRA models include the numerical designation “3” followed by a respective letter (e.g., B, C, E, and K), indicating that each of these LoRA models was fine-tuned using the base model BM #3.

The memory storage of inference engine 134 is subdivided into KV cache memory 132, LoRA weights memory 136, and base model LoRA weights base weight memory 140. In FIG. 1A, LoRA weights memory 136 is illustrated as being occupied by the following LoRA models: LoRA 4B 138a, LoRA 4C 138b, LORA 4E 138c, and LoRA 4M 138d. Base model weights base weight memory 140 is illustrated as being occupied by BM 4 weights 142. Here, all the LoRA models include the numerical designation “4” followed by a respective letter (e.g., B, C, E, and M), indicating that each of these LoRA models was fine-tuned using the base model BM #4.

Requests to generate an inference response using a particular base model and optionally a particular LoRA model are received at queue 102. Load balancer/controller 104 determines where to route the requests (e.g., to queue 106a, queue 106b, or queue 106c). Load balancer/controller 104 can also determine: (1) if a different base model or LoRA model needs to be loaded into one of the inference engines to accommodate one of the requests; (2) if additional instances of a base model or LoRA model are needed in order to achieve load balancing; (3) when a new/another model is being loaded on a fully occupied inference engine, which base model or LoRA model should be replaced by the new/another model; and (4) the order in which the requests are queued/batched to improve efficiency.

FIG. 1A illustrates an example when series of requests 144 are in queue 102 waiting to be sent to one of the queues of the respective inference engines. For example, request 144a is a prompt that is designated to be processed by BM #1 and LoRA 1B 114b. Similarly, request 144c is a prompt that is designated to be processed by BM #4 and LoRA 4B 138a, and request 144n is a prompt that is designated to be processed by BM #3 without using a LoRA model. The following requests are shown in queue 102: request 144a, request 144b, request 144c, request 144d, request 144e, request 144f, request 144g, request 144h, request 144i, request 144j, request 144k, request 144l, request 144m, request 144n, request 1440, and request 144p.

FIG. 1B illustrates system 100 after load balancer/controller 104 has sorted and routed the requests 144 to queue 106a, queue 106b, and queue 106c.

For example, request 144a, request 144e, 244f, and request 144h are routed to queue 106a because they are designated to be processed by LoRA 1A 114a and LoRA 1B 114b, which are already loaded in inference engine 110. Request 144b and request 144i are each designated to be processed by LoRA 1H 114d, which is not yet loaded on inference engine 110. Because inference engine 110 only has three of the four available openings that are occupied, load balancer/controller 104 can cause LoRA 1H 114d to be loaded into the available opening. The dashed line on LoRA 1H 114d indicates that it is being loaded on to inference engine 110 and that LoRA 1H 114d was not previously on inference engine 110.

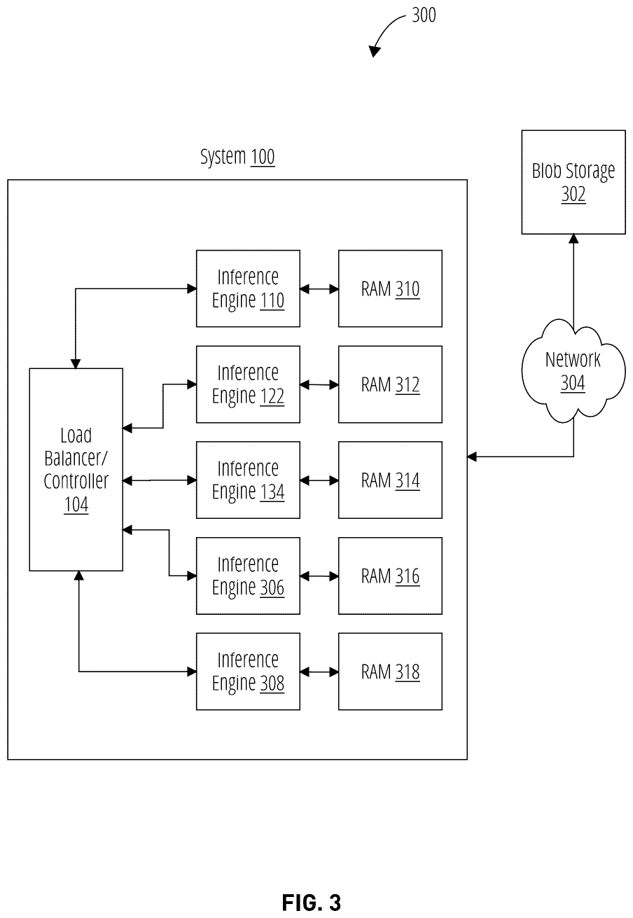

As discussed below with reference to FIG. 3, LoRA 1H 114d can be in system 100 on RAM 310, in which case the time needed to load LoRA 1H 114d on to inference engine 110 maybe relatively short. Alternatively, LoRA 1H 114d might not be in system 100 on RAM 310, in which case system 100 may request a copy of LoRA 1H 114d be sent from blob storage 302 via network system 300, and that process might be relatively slow.

According to certain non-limiting examples, load balancer/controller 104 can keep request 144b and request 144i in queue 102 while LoRA 1H 114d is still being loaded on inference engine 110. This keeps queue 106a from becoming congested with requests that cannot yet be processed. Then when LoRA 1H 114d is completely loaded on inference engine 110, load balancer/controller 104 can add request 144b and request 144i to queue 106a.

Load balancer/controller 104 moves request 144c, request 144j, request 144n, and request 1440 to queue 106b because they are designated to be processed by LoRA 3B 126a, LORA 3E 126c, and BM #3 without a LoRA model, which are already loaded in inference engine 122. Request 144g, request 144k, and request 144g are each designated to be processed by LoRA 3G 126e, which is not yet loaded on inference engine 110. Because all four LoRA openings are already occupied, load balancer/controller 104 can remove one of the currently loaded LoRA models to make room for LoRA 3G 126e. Various protocols can be used to determine which LoRA to remove. For example, the LoRA models can be prioritized to remove the LoRA model that was least recently used (e.g., the longest dormant or unused LoRA model) and that does not have any requests in the queue. In FIG. 1B, LoRA 3K 126d was removed to make room for LoRA 3G 126e. Again the dashed line indicates that LoRA 3G 126e is being newly loaded on inference engine 122. Request 144g, request 144k, and request 144g are kept in queue 102 until LoRA 3G 126e is completely loaded on inference engine 122.

Load balancer/controller 104 moves request 144d, request 144l, and request 144p to queue 106c because they are designated to be processed by LoRA 4B 138a, LoRA 4E 138c, and BM #4 without a LoRA model, which are already loaded in inference engine 122.

Request 144m is designated to be processed by LoRA 2A, which is not loaded on any of the inference engines illustrated in FIG. 1B. LoRA 2A is a LoRA model based on BM #2, and none of the inference engines shown has loaded BM weights for BM #2. Another inference engine that is not shown can have BM #2 loaded, and LoRA 2A can be loaded on this other inference engine, if it is not already loaded. Then, request 144m can be added to the queue of the other inference engine. Otherwise, BM #2 and LoRA 2A can be loaded on an inference engine that is not yet in operation, or an inference engine that is in operation can be overwritten to load BM #2 and LoRA 2A.

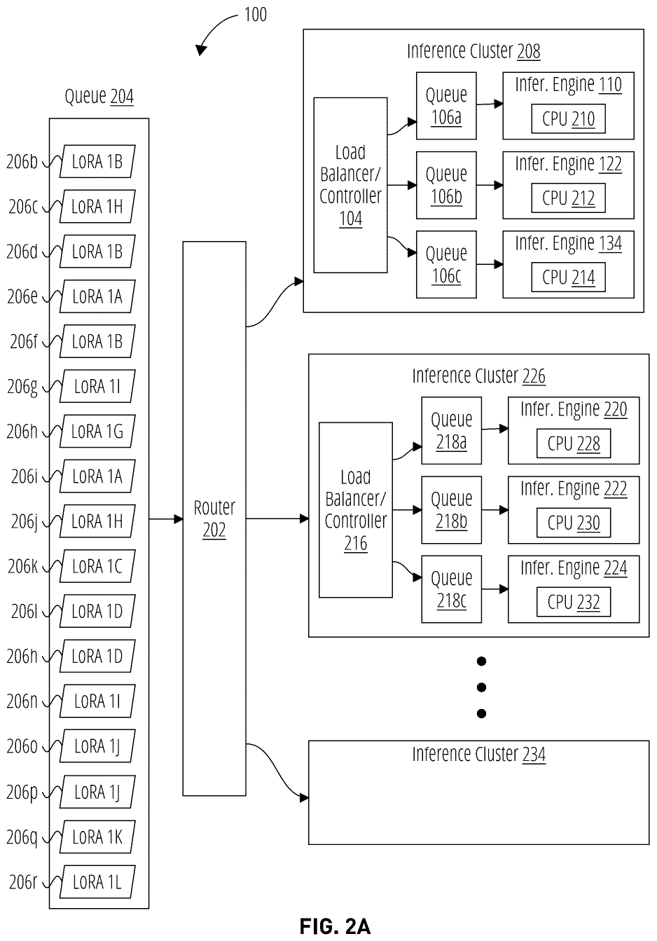

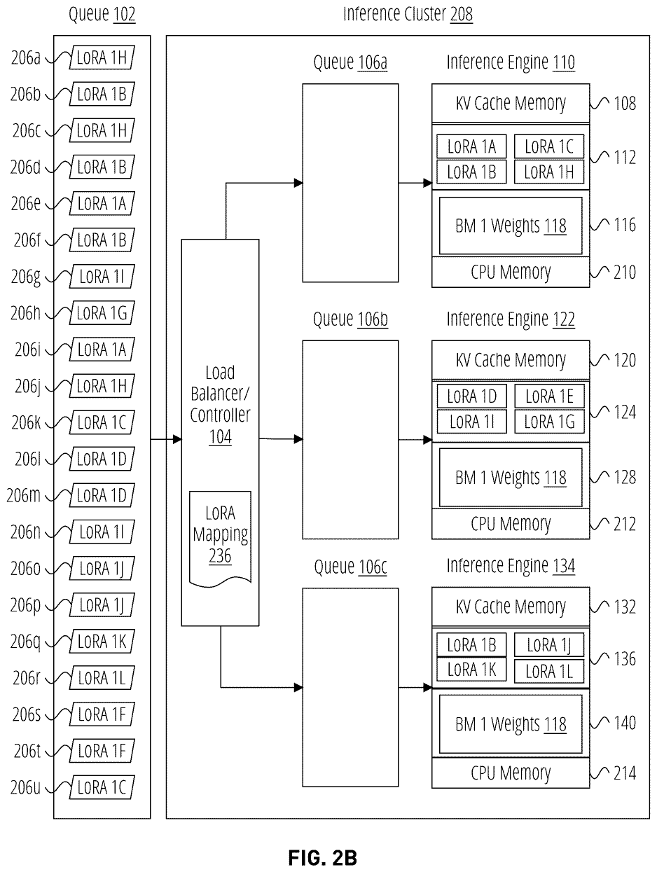

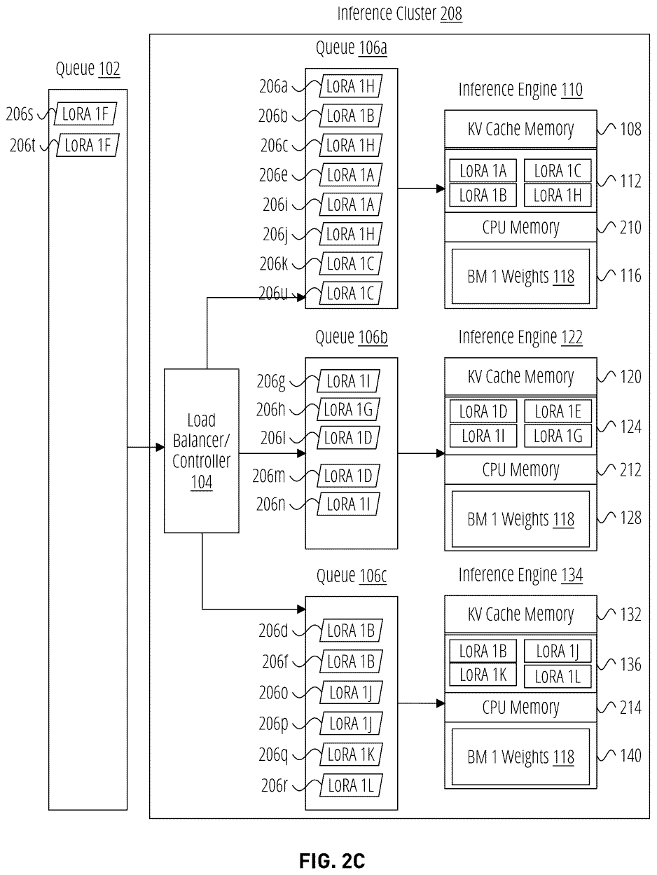

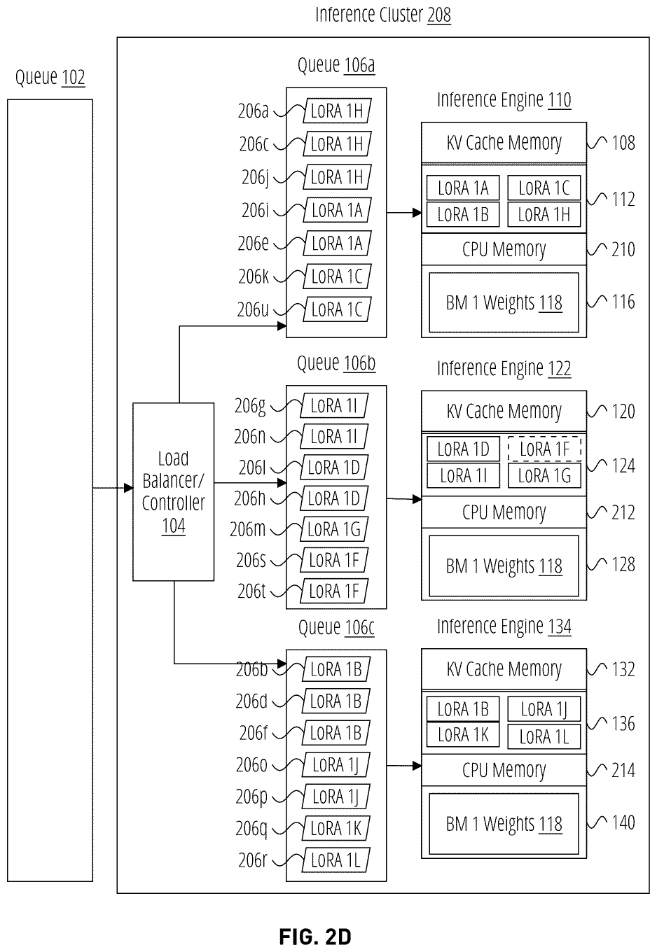

FIGS. 2A-2D illustrate a non-limiting example in which system 100 includes a large number of inference engines, such that the inference engines are arranged in respective inference clusters, and each inference cluster includes one or more inference engines all with the same base model. For example, inference cluster 208 can have BM 1 weights 118 loaded onto inference engine 110, inference engine 122, and inference engine 134. According to certain non-limiting examples, requests received in queue 204 are routed via router 202 to respective inference clusters based on which base model is indicated by a given request, and a load balancer at the inference cluster determines which inference engine within the inference cluster receives and processes the given request. For example, load balancer/controller 104 of inference cluster 208 controls which inference engines within inference cluster 208 the given request is processed by.

Inference cluster 208 can include load balancer/controller 104, queue 106a, queue 106b, queue 106c, inference engine 110, inference engine 122, and inference engine 134. Each of the inference engines can include multiple graphics processing units (GPUs) and one or more central processing units (CPUs), which can collectively be referred to as processors. The processors can perform various tasks for the fine-tuned models. For example, the GPUs can perform computations for layers of a neural network or deep learning model, and the model weights can be stored in the GPU memory. CPU memory (e.g., CPU random access memory (RAM)) can be connected to the GPUs via a high-speed bus (e.g., a PCIe bus), such that weights for a LoRA model not currently loaded in GPU memory can be stored in CPU memory, enabling these weights to be quickly loaded into GPU memory if a request is received that uses the LoRA model. Thus, some LoRA models that are not in GPU memory can be cached near the GPU memory. In the non-limiting example shown in FIG. 2A, each inference engine includes one or more CPUs. For example, inference cluster 208 includes: (1) inference engine 110 which is associated with CPU memory 210; (2) inference engine 122 which is associated with CPU memory 212; and (3) inference engine 134 which is associated with CPU memory 214.

Similar to inference cluster 208, inference cluster 226 includes a load balancer (e.g., load balancer/controller 216) that directs requests to respective queues (e.g., queue 218a, queue 218b, and queue 218c) associated with the inference engines (e.g., inference engine 220, inference engine 222, and inference engine 224). Inference engine 220 includes CPU 228. Inference engine 222 includes CPU 230, and inference engine 224 includes CPU 232). System 100 can also include additional inference clusters (e.g., inference cluster 234).

The system comprises a load balancer/controller 104, a queue 106a, a queue 106b, a queue 106c, an inference engine 110, an inference engine 122, an inference engine 134, a router 202, a queue 204, a request 206b, a request 206c, a request 206d, a request 206e, a request 206f, a request 206g, a Request 206h, a request 206i, a request 206j, a request 206k, a request 206l, a request 206n, a request 2060, a request 206p, a request 206q, a request 206r, an inference cluster 208, a CPU memory 210, a CPU memory 212, a CPU memory 214, a load balancer/controller 216, a queue 218a, a queue 218b, a queue 218c, an inference engine 220, an inference engine 222, an inference engine 224, an inference cluster 226, a CPU 228, a CPU 230, a CPU 232, and an inference cluster 234.

FIG. 2B shows a non-limiting example of inference cluster 208. Inference cluster 208 looks similar to system 100 in FIG. 1A. In FIG. 2B, inference engine 110 includes four sections of memory: KV cache memory 108, LoRA weights memory 112, base model weights memory 116, and CPU memory 210. For all inference engines in inference cluster 208, the base-weight storage stores (e.g., base model weights memory 116, base weight memory 128, and base weight memory 140) each store the weights for BM #1 (e.g., BM 1 weights 118).

In inference engine 110, LoRA weights memory 112 stores the weights for the four LoRA models: LoRA 1A; LORA 1B; LORA 1C; and LoRA 1H. CPU memory 210 can provide cache memory for inference engine 110 that stores weights of other LoRAs that are not currently stored in LoRA weights memory 112.

In inference engine 122, LoRA weights memory 124 stores the weights for the four LoRA models: LoRA 1D; LORA 1E; LORA 1I; and LoRA 1G. CPU memory 212 can provide cache memory for inference engine 122 that stores weights of other LoRAs that are not currently stored in LoRA weights memory 124.

In inference engine 134, LoRA weights memory 136 stores the weights for the four LORA models: LoRA 1B; LORA 1J; LORA 1K; and LoRA 1L. CPU memory 214 can provide cache memory for inference engine 134 that stores weights of other LoRAs that are not currently stored in LoRA weights memory 136.

Queue 102 includes several requests-request 206a, request 206b, request 206c, request 206d, request 206e, request 206f, request 206g, request 206h, request 206i, request 206j, request 206k, request 206l, request 206m, request 206n, request 2060, request 206p, request 206q, request 206r, request 206s, request 206t, and request 206u.

FIG. 2B shows load balancer/controller 104 includes LoRA mapping 236 that tracks for respective inference engines which LoRA models are stored in the LoRA weights memory (e.g., GPU memory) and which LoRA models are stored in the CPU memory. According to certain non-limiting examples, LoRA mapping 236 can also track the number of pending requests in the queues of the respective inference engines. According to certain non-limiting examples, LoRA mapping 236 can also track which LoRA models are to be used to process the respective requests.

FIG. 2C illustrates system 100 after load balancer/controller 104 has directed the requests to queue 106a, queue 106b, and queue 106c.

For example, request 206a, request 206b, request 206c, request 206e request 206i, request 206j, request 206k, and request 206u are routed to queue 106a because they are designated to be processed by the LoRA models that are already loaded in inference engine 110. Similarly, request 206g, request 206h, request 260l, request 206m, and request 206n are routed to queue 106b because they are designated to be processed by the LoRA models that are already loaded in inference engine 122. Request 206d, request 206f, request 2060, request 206p, request 206q, and request 206r are routed to queue 106c because they are designated to be processed by the LoRA models that are already loaded in inference engine 134.

LoRA 1B is loaded on inference engine 110 and inference engine 134, and therefore the requests that use LoRA 1B can be routed to either of these inference engines. In FIG. 2B request 206b has been routed to inference engine 110, whereas request 206d and request 206f have been routed to inference engine 134. Load balancing can be achieved by sending the requests using LoRA 1B to the inference engine that currently has LoRA 1B loaded and has the fewest requests in its queue.

Request 206s and request 206t both use LoRA IF, which is not currently loaded on any of the inference engines and therefore remain in queue 102.

In FIG. 2D, load balancer/controller 104 determines that none of the requests uses LORA 1E, which was loaded on inference engine 122. Thus, load balancer/controller 104 directs inference engine 122 to replace LoRA 1E with LoRA IF (shown with a dashed boarder while it is being loaded. A copy of LoRA can be kept in CPU memory 212, to provide caching in case a future request uses LoRA 1E. border.

Further, FIG. 2D shows an example of load balancing by sending request 206b to queue 106c rather than to queue 106a. Additionally, requests that use the same LoRA model can be grouped together to enable batching of requests that use the same LoRA model.

As discussed below, the decision process performed by load balancer/controller 104 to determine to which inference engine the respective requests are directed can be informed by:
1. which inference engines have the requested LoRA model in GPU memory (e.g., LoRA weights memory 112),
2. which inference engines have the requested LoRA model cached in CPU memory (e.g., CPU memory 210) but not in GPU memory, and
3. how many requests are already in queues for the respective inference engines?

According to certain non-limiting examples, a request can be directed an inference engine that has the requested LoRA model already loaded in GPU memory. If there are no inference engines that have the requested LoRA model in GPU memory, then a request can be directed an inference engine that has the requested LoRA model cached in CPU memory. If there are no inference engines for which the requested LoRA model in either GPU memory or in CPU memory, load balancer/controller 104 can direct one of the inference engines to load the requested model (e.g., load the LoRA model of CPU cache) from a network storage (e.g., binary large object (blob) memory storage). When a disparity in the number of requests among the engine queues becomes sufficiently large, a request can be sent to an inference engine with a shorter queue, even though it does not currently have the LoRA model loaded, and this inference engine can be directed to load the requested LoRA model. Thus, load balancer/controller 104 can mitigate larger differences in queue lengths to achieve load balancing.

FIG. 3 illustrates a network system 300 that includes system 100 connected to blob storage 302 via network 304. Similar to FIG. 1A and FIG. 1B, system 100 includes load balancer/controller 104, inference engine 110, inference engine 122, inference engine 134, inference engine 306 and inference engine 308. Each of the inference engines is connected to one of random access memories: RAM 310, RAM 312, RAM 314, RAM 316, RAM 318.

For example, the RAMs can be memories corresponding to CPUs that are associated with the respective inference engines. The RAMs can store LoRA models that are frequently used, but for which there is insufficient space on the dedicated memory for LoRA weights (e.g., the LoRA weights memory). According to certain non-limiting examples, the LoRA weights memory can be sufficiently large to accommodate five hundred LoRA models at a given time, whereas one of the RAMs can be sufficiently large to accommodate one thousand LoRA models at a given time. When a LoRA model is requested but is not loaded on one of the inference engines, load balancer/controller 104 can first determine whether the requested LoRA model is in RAM. When the LoRA model is in RAM, load balancer/controller 104 can load the requested LoRA model from RAM to the inference engine. Otherwise, load balancer/controller 104 can request the requested LoRA model from blob storage 302, which can be slower than loading it from RAM.

According to certain non-limiting examples, load balancer/controller 104 determines which currently dormant LoRA models to remove to make room for the requested LoRA model. As discussed above, various protocols or rules can be used to determine which LoRA models are removed and which stay. For example, the rule can be that the least frequently used models are the first to be removed. Alternatively, the longest dormant LoRA model can be the first removed. The rule for removing LoRA models from the LoRA weights memory can be the same or different for which LoRA models are removed from RAM to accommodate LoRA models retrieved from blob storage 302.

According to certain non-limiting examples, the inference engines are autoregressive large language models (LLMs) that only pull one token at a time and append that token to an inferred response before doing another forward pass to generate the next token, and so forth until the response is complete. To be efficient, the inference engines collectively perform 1000s of queries in parallel (e.g., about 10-100 quarries by each inference engine). Although each query might return in about one second, it is possible to perform about 1000-queries at one time, making it possible to serve a large number of customers. In this context, a coordination challenge can arise when going from using a few versions of the base model to a scenario in which a large number of customers each have and use their own finely tuned model. Even though the LoRA models can be much smaller (e.g., 1000× smaller) than the base model, swapping out the weighting coefficients for each query can be inefficient. Even more inefficient would be swapping out the weighting coefficients between forward passes per token. For example, if the 1000-queries being processed in parallel each use different LoRA models and the inference engines lack sufficient space to simultaneously store one thousand different LoRA models. Accordingly, it can be advantageous to batch queries using the same LoRA models to be processed together in parallel. Also it can be advantageous to have multiple LoRA models loaded on a single inference engine to be able to process requests for different LoRA engines in parallel. Further, being able to dynamically queue requests such that requests for the same LoRA that are received at different times can be grouped and batched to be performed together. Rather than requiring customers to specify and pay for a particular time when they have their LoRA loaded on the inference engine, the systems and methods disclosed herein for queueing and batching requests together with the dynamic approach to swapping in different LoRA models on the inference engine enables customers to make a request using their fine-tuned model at any time, and the systems and methods disclosed herein can dynamically, just in time, load the customer's fine-tuned model and then keep it cached until it has been dormant for a significant time.

According to certain non-limiting examples, system 100 can have a fleet of inference engines. For example, an inference engine can include one or more machines that have GPUs and they hold the weight for the base model. When a customer fine-tunes the base model (e.g., GPT-4). The customer provides their own data set for the particular problem(s) the customer wants to solve, and, for the tuning process, the customer can select various hyperparameters, which provide configuration options. As discussed below, the customer's data set is applied to the combination of the base model and the LoRA model with weights of the base model being frozen and the weights of the LoRA model are adjusted to minimize an error/objective function. The optimized LoRA weights for the customer's data set are then stored together with an identifier (ID) that can be used to recall the LoRA weights when a request with the ID is received. Thus, the customer can use the provided ID to select their own fine-tuned model, rather than using the base model.

As discussed above, a single inference engine for a base model can also store weights for multiple LoRA models that can be applied on top of the base model, and a batch of requests using the respective LoRA models can all be performed in parallel. This architecture of loading multiple LoRA models on a single inference engine can be referred to as a multi-LoRA architecture. As discussed above, a GPU has a given amount of memory (e.g., 80 gigabytes of memory) that can be subdivided and used for various tasks such as KV cache, storing weights for the base model and storing weights for the fine-tuned models (e.g., LoRA models). An inference engine can include multiple GPUs. For a given inference engine, the base weights are subdivided among the GPUs, and, for each LoRA model loaded on the inference engine, the LoRA weights are similarly subdivided among the GPUs. The base weights and the LoRA weights for the same layers/blocks of the neural network architecture are loaded on the same GPU of the inference engine. For example, when the base weights for the first multi-head attention layer are on GPU #1, then the LoRA weights for the first multi-head attention layer are on GPU #1.

According to certain non-limiting examples, when a LoRA model is requested but is not currently loaded on an inference engine, the weights can be retrieved from either CPU RAM (e.g., RAM 310) or from network storage (e.g., blob storage 302) and loaded on the inference engine. Retrieving the weights from CPU RAM can be much faster than retrieving the weights from network storage. Thus, load balancer/controller 104 can first look for the LoRA weights in CPU RAM. For example, load balancer/controller 104 can use a caching hierarchy in which load balancer/controller 104 saves the LoRA model first in CPU RAM, and then load balancer/controller 104 loads it onto the GPU. The caching of the GPU memory can operate with a certain number of LoRA slot (e.g., FIG. 1A is illustrated using the non-limiting example of each inference engine having four LoRA slots). Generally, the number of LORA slots depends on the amount of memory allocated to storing LoRA weights and the number of weights per LoRA.

According to certain non-limiting examples, system 100 can accommodate LoRA models of different sizes. For example, a performance boost can be achieved by increasing the number of weights in the LoRA, but a larger data set is needed to fine-tune a LoRA having more weights. The increased number of weights can be used to apply additional LoRA matrices to additional layers of the neural network architecture. For example, a smaller LoRA might only apply LoRA matrices to the attention layers, whereas a larger LoRA applies LoRA matrices to both the attention layers and the feed-forward layers. Additionally or alternatively, the increased number of weights can be used to increase the rank of the LoRA matrices. Depending on the use case and needs of the customers, different sizes of LoRA models may be useful for different problems and applications. For example, some LoRA models can occupy a single slot, whereas other LoRA models can occupy multiple slots (e.g., 2, 3, 4, or 5 slots).

According to certain non-limiting examples, an inference engine can have more CPU RAM than GPU memory. Load balancer/controller 104 can fetch a requested LoRA model over network 304 from blob storage 302, then 104 can first cache the requested LoRA model in CPU RAM, and, from CPU RAM, load balancer/controller 104 can load the requested LoRA model on the GPU. When the LoRA slots on the GPU are full, load balancer/controller 104 will first evict another LoRA (e.g., a lesser-used LoRA) from the GPU, but the evicted LoRA will still be on CPU RAM. When a request is received to use the evicted LoRA, load balancer/controller 104 can reload the evicted LoRA back to GPU memory from CPU RAM without having to go back and fetch it over the network from blob storage. According to certain non-limiting examples, blob storage 302 may hold millions of LoRA models, the CPU RAM may have the capacity to hold 2000 LoRA models, and the GPU memory may have the capacity to hold 500 LoRA models.

According to certain non-limiting examples, the amount of memory on the GPUs that is dedicated to KV cache versus LoRA weights can be dynamically adjusted. For example, when only a few LoRA models are being used (e.g., a few larger customers are running big jobs that completely occupy one inference engine for an extended time), the amount of memory allocated for LoRA weights can be decreased, freeing up more memory for KV cache, and thereby allowing more key values to be stored and more request to be processed in parallel.

According to certain non-limiting examples, the scheduling logic, queueing logic, and batching logic which is applied by load balancer/controller 104 to requests 144 as well as the subbing logic applied by load balancer/controller 104 to determine when and which LoRA models are subbed in and out of GPU memory and CPU memory can be governed by various rules or protocols. For example, load balancer/controller 104 can prioritize requests for LoRA models that are already loaded on the GPU. Further, for a request to use a LoRA model that is not on the GPU but is on CPU memory, load balancer/controller 104 can instruct the appropriate inference engine, and, when the requested LoRA model has been loaded from the CPU to the GPU memory, the request is handled using the requested LoRA model (e.g., load balancer/controller 104 send the request to the inference engine with an instruction to handle the request). When a LoRA model is requested that is not on GPU or CPU memory, load balancer/controller 104 fetches the requested LoRA model from blob storage 302 via network 304. The request is then processed after the process of loading the requested LoRA model to the GPU is complete. Load balancer/controller 104 can prioritize the requests that can be done first while moving the requests that require unfulfilled prerequisites (e.g., loading the requested LoRA model on the GPU memory) to the back of the queue. Further, requests using the same LoRA models can be batched to be performed together (e.g., in parallel) on the same inference engine, even when they arrive at different or random times. Additionally, this prioritization can also be sensitive to latency for individual requests. For example, a given request (or set of requests) will not be crowded out request using frequently applied LoRA models or otherwise be kept at the back of the queue for an extended period because they use a rarely used LoRA model. That is, the logic of load balancer/controller 104 can balance the objective of being efficient by prioritizing requests that can be performed by readily accessible LoRA models (e.g., LoRA models already loaded on the GPUs of the inference engine) with the objective of avoiding long latencies or starving requests for infrequently used LoRA models that are fetched from blob storage 302.

According to certain non-limiting examples, requests for LoRA models already on the GPUs can be handled immediately, whereas a request for a LoRA model on the CPU memory can take a first period to load on the GPUs (e.g., 50 milliseconds) before the request can be handled. Similarly, a request for a LoRA model that must be fetched over the network can take a second period to load on the GPUs (e.g., 5 seconds) before the request can be handled. Further, a queue of an inference engine (e.g., queues 106) can have a predefined depth (e.g., 2000 requests), and an incoming request designates a LoRA model that is loaded on a first inference engine having a first number of requests (e.g., 1000-requests) pending in its queue.

The logic on load balancer/controller 104 can evaluate the tradeoffs between the advantages of adding the incoming request behind the 1000-requests for the first inference engine with the advantages of loading the LoRA model on a second inference engine having queue having a second number of requests (e.g., 200 requests) pending in its queue. Depending on the relative values of the numbers of pending requests in the queues of the respective inference engines and other aspects of system 100 (e.g., how long it takes to process a request, the average throughput of the respective inference engines, the size of the LoRA model, how long it takes to load the LoRA model, the power consumed by loading the LoRA model, etc.), the tradeoffs will merit either creating an instance of the LoRA model on the second inference engine or not.

According to certain non-limiting examples, the logic on load balancer/controller 104 can be cache aware, such that the inference engine selected for deploying another instance of the LoRA model is based not only on which inference engine has the fewest requests in its queue but also on the LoRA's position in the cache hierarchy of the respective inference engines. For example, an inference engine with more requests in its queue but having the requested LoRA model in its CPU memory can be preferable to another inference engine with fewer requests in its queue but having to fetch the requested LoRA model via the network (e.g., from blob storage 302).

According to certain non-limiting examples, load balancer/controller 104 can be aware of which requested LoRA models that are not currently loaded on an inference engine are in the process of being loaded from CPU memory or fetched via the network, and load balancer/controller 104 can be aware of how much time remains until the requested LoRA models are loaded on an inference engine. Further, according to certain non-limiting examples, as additional LoRA models are loaded on inference engines. load balancer/controller 104 can rearrange and reprioritize the requests within and among the respective queues.

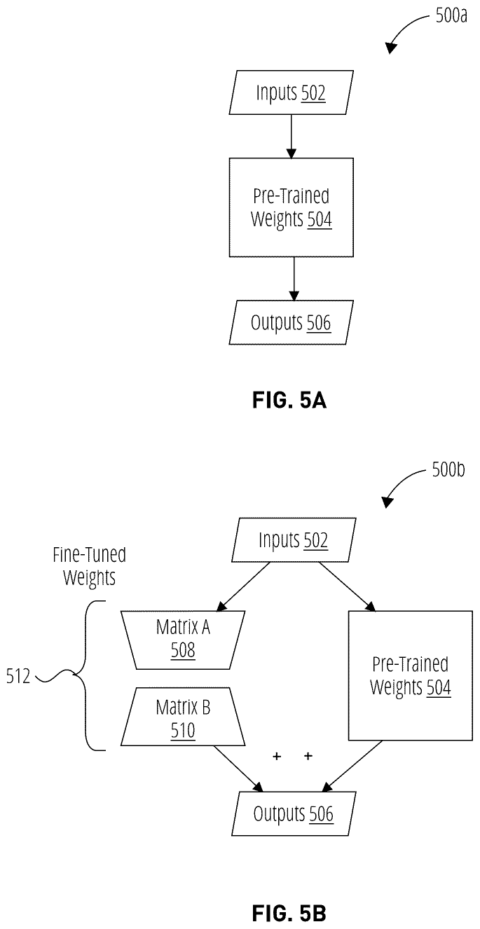

According to certain non-limiting examples, the inference engines process the requests using single-forward-pass token generation, which the inference engine performs a full pass through all layers of a neural network to pull out one token. The inference engine can align the requests to pull a respective token for multiple requests (e.g., the inference engine can process one hundred requests in parallel). In a case in which a customer makes ten requests at the same time for their LoRA model, these ten requests can be handled as a batch, in parallel by the inference engine. For example, the ten requests for the customer's LORA model can be handled side-by-side in the batch by using pointers indicating that requests zero through nine are for the requested LoRA model. Similarly, if a second set of six requests are for LoRA model “B,” these six requests can be indexed as requests ten through fifteen and pointers can be used to indicate that requests ten through fifteen are performed using LoRA model “B,” and so forth. Thus, for each forward pass, the inference engine can align the requests with their respective LoRA models. The forward passes are performed using matrix multiplications of the key values with the BM weights and matrix multiplications of the key values with the LoRA weights indicated by the pointers and then adding the results of a base-weight matrix multiplication to the corresponding LoRA-weight matrix multiplication, as discussed below with reference to FIG. 5B.

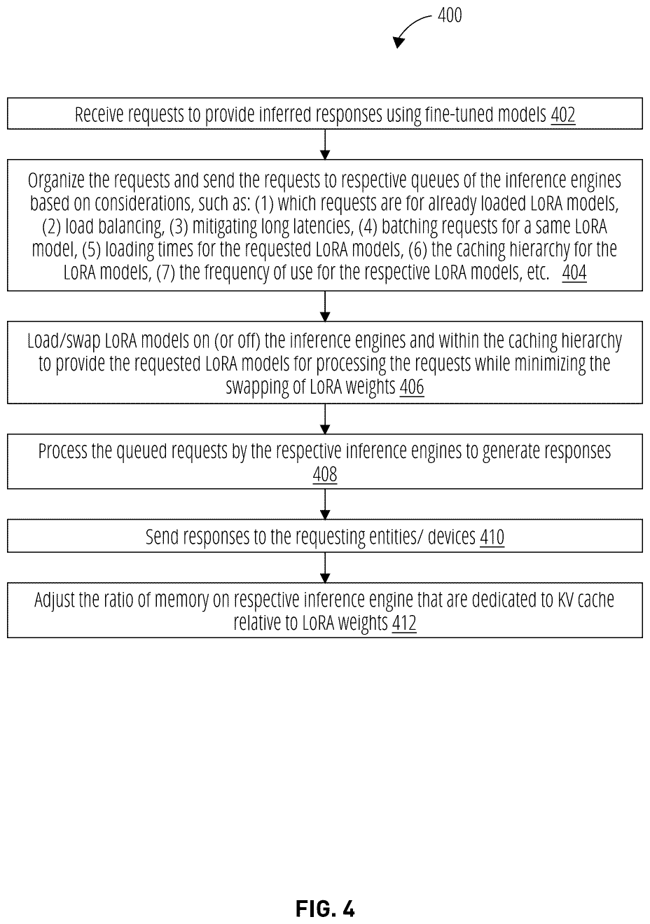

FIG. 4 illustrates an example method 400 for processing generative responses to requests for fine-tuned models in a way that increases processing efficiency and minimizes latency when generating responses in parallel using multiple fine-tuned models (e.g., low-rank adaptation (LoRA) models). Although the example method 400 depicts a particular sequence of operations, the sequence may be altered without departing from the scope of the present disclosure. For example, some of the operations depicted may be performed in parallel or in a different sequence that does not materially affect the function of method 400. In other examples, different components of an example device or system that implements method 400 may perform functions at substantially same time or in a specific sequence.

According to certain non-limiting examples, method 400 uses a generative response system (e.g., system 100) that includes generative inference engines (e.g., inference engines 110, 122, and 134) on each of which multiple fine-tuned models can be simultaneously loaded. Load balancer/controller 104 can determine the order in which requests for respective fine-tuned models are queued/batched. For example, the requests that use currently loaded models (e.g., models currently on an engine) can be processed first. On the other hand, the requests using LoRA model that are not currently loaded cannot be processed until the requested LoRA models have been loaded onto one of the inference engines. That is, a request for a currently not loaded LoRA model is processed after swapping the requested model onto one of the inference engines, according to a caching hierarchy. The requested model can be swapped onto the inference engine to replace a long-dormant or infrequently used LoRA model. The caching hierarchy can include that, after swapping out a model from the inference engine, a system copy of the model is maintained in system memory (e.g., CPU RAM) for easy retrieval in case the model is subsequently requested. After not being requested for an extended time, the system copy of the model can be removed and a network copy maintained in network storage (e.g., blob storage 302).

According to some examples, step 402 of the method includes receiving requests to provide inferred responses using fine-tuned models. For example, system 100 illustrated in FIG. 1A may receive requests to provide inferred responses using fine-tuned models.

According to some examples, step 404 of the method includes organizing the requests and send the requests to respective queues of the inference engines based on considerations, such as: (1) which requests are for already loaded LoRA models, (2) load balancing, (3) mitigating long latencies, (4) batching requests for a same LoRA model, (5) loading times for the requested LoRA models, (6) the caching hierarchy for the LoRA models, (7) the frequency of use for the respective LoRA models, etc.

For example, load balancer/controller 104 illustrated in FIG. 1A may organize the requests and send the requests to respective queues of the inference engines based on considerations.

According to some examples, step 406 of the method includes loading LoRA models on the inference engines and to clear up space for the newly loaded models swapping off LoRA models that are, for example, infrequently used or have long been dormant/unused. The actions of swapping LoRA models on and off the inference engines can be performed according to the caching hierarchy, thereby providing the requested LoRA models that are to be used for processing the requests while minimizing the amount of swapping of the LoRA weights.

According to certain non-limiting examples, step 406 can be performed according to any of the techniques and processes discussed above with reference to FIG. 1A. FIG. 1B, and/or FIG. 3.

According to some examples, step 408 of the method includes processing the queued requests by the respective inference engines to generate responses.

For example, inference engines 110, 122, and 134 illustrated in FIG. 1A may process the queued requests to generate the responses. According to certain non-limiting examples, step 408 can be performed according to any of the techniques and processes discussed above with reference to FIG. 1A. FIG. 1B, and/or FIG. 3.

According to some examples, step 410 of the method includes sending responses to the requesting entities/devices. For example, system 100 illustrated in FIG. 1A may send the responses generated by the inference engines to the requesting entity/device. According to certain non-limiting examples, step 410 can be performed according to any of the techniques and processes discussed above with reference to FIG. 1A. FIG. 1B, and/or FIG. 3.

According to some examples, step 412 of the method includes adjusting the ratio of memory on respective inference engine that are dedicated to KV cache relative to LoRA weights.

For example, load balancer/controller 104 illustrated in FIG. 1A may reallocate the memory on inference engine 110 between KV cache memory 108 and LoRA weights memory 112. According to certain non-limiting examples, step 312 can be performed according to any of the techniques and processes discussed above with reference to FIG. 1A. FIG. 1B, and/or FIG. 3.

FIG. 5A and FIG. 5B illustrate an example of fine-tuning using low rank adaptation (LoRA). FIG. 5A illustrates a part of a neural network. For example, in a transformer architecture (e.g., transformer architecture 800), pre-trained layer 500a can be a multi-head attention block (e.g., multi-head attention block 822) or a feed forward block (e.g., feed forward block 826). In pre-trained layer 500a, pre-trained weights 504 receive inputs 502 and generate outputs 506.

Low-rank adaptation (LoRA) is a method that introduces low-rank matrices into the model to adjust the output of each layer without significantly increasing the number of parameters, thereby providing efficient fine-tuning. Instead of fine-tuning all the weights in the model, LoRA introduces small learnable matrices into specific parts of the model (e.g., attention heads or feed-forward layers) and adapts only those matrices during fine-tuning. This approach can be parameter-efficient and computationally cheaper than full fine-tuning, making it beneficial for fine-tuning very large models.

FIG. 5B illustrates using LoRA to fine-tune the pre-trained layer to generate fine-tuned layer 500b. Fine-tuned weights 512 include matrix A 508 and matrix B 510. For example, matrix A 508 is a dᵢₙₚᵤₜ×r matrix and matrix B 510 can be an r×dₒᵤₜₚᵤₜ matrix, where dᵢₙₚᵤₜ is the dimension of inputs 502, dₒᵤₜₚᵤₜ is the dimension of outputs 506, and r is the dimension of the reduced rank, which can be much smaller than both dᵢₙₚᵤₜ and dₒᵤₜₚᵤₜ. Thus, the number of fine-tuned weights 512 can be much smaller than the number of pre-trained weights 504. Other fine-tuning methods can also be used. The fine-tuning may be improved by increasing the value of r, but increasing the value of r can also necessitate increasing the size of the training set used for fine-tuning.

LoRA can be used to efficiently fine-tune large pre-trained models, especially when adapting them to new tasks or domains. As discussed above, LoRA is used to reduce the number of parameters that need to be updated during fine-tuning by introducing low-rank parameterizations. This method is particularly useful when dealing with large models that are computationally expensive to retrain. A large model (e.g., a transformer, deep neural network) can be pre-trained on a massive amount of data and have learned generalizable representations. These models have a large number of parameters, which are computationally expensive to fine-tune for specific tasks. Instead of fine-tuning the entire model, LoRA introduces low-rank matrices that are added to certain layers of the model. These low-rank matrices approximate changes needed for adapting the model to new tasks.

LoRA has many advantages. LoRA can make fine-tuning more efficient because only a small number of parameters are modified. LoRA can be more computationally efficient. By reducing the number of trainable parameters, LoRA reduces the overall computational cost of fine-tuning. LoRA can provide better generalization. By keeping the majority of the model fixed, LoRA allows the pre-trained model's generalization capabilities to be retained while adapting to the new task. LoRA can provide improved memory efficiency because it requires less memory during fine-tuning since fewer parameters need to be stored and updated.

Using LoRA to fine-tune ML model is one non-limiting example, and other fine-tuning methods can be used. Other non-limiting examples of methods for fine-tuning include, but are not limited to, full fine-tuning (also referred to as end-to-end fine-tuning), adapter-based fine-tuning, partial fine-tuning (freezing some layers), a combination of prompt engineering and fine-tuning, parameter-efficient fine-tuning (PEFT), multi-task learning, reinforcement learning, regularization techniques, and adding task-specific layers.

In full fine-tuning, all parameters of the model are fine-tuned using a task-specific dataset. For example, a pre-trained model undergoes additional training using a new, task-Sub specific dataset. This allows the model to adjust all of its parameters to better solve the specific task.

Adapters are small modules that are inserted into a pre-trained model to allow task-specific customization without modifying the entire model. These adapters are trained while the rest of the model's parameters remain frozen. For example, adapters can be lightweight neural networks (e.g., small feedforward neural networks) that are inserted into the layers of the model. Only the parameters of the adapter are updated during fine-tuning, while the rest of the model (usually the transformer layers) remains frozen. This makes the fine-tuning process computationally efficient.

Another approach for fine-tuning is to unfreeze only certain parts of the model and fine-tune those layers while keeping the rest of the model frozen. This can save computational resources and prevent overfitting, e.g., when the dataset is small. Partial fine-tuning can be realized by selectively unfreezing some of the model's layers, such as the top few transformer layers (e.g., the last one to two layers of the transformer network). These unfrozen layers can capture high-level, task-specific features, while the lower layers capture more general language knowledge. Only the unfrozen layers are trained on your task-specific data, and the rest of the model's parameters are frozen (i.e., they are not updated during backpropagation).

According to certain non-limiting examples, fine-tuning can also be combined with prompt engineering techniques. Prompt engineering involves designing specific prompts that can guide the model to perform a given task effectively. For example, if you want the model to answer questions, you could prepend each input with “Answer the following question:” or “Summarize the text below.” After selecting one or more prompt formulations, the model can be fine-tuned on the selected prompts to improve its performance for the specific task.

There are other methods of fine-tuning. Parameter-efficient fine-tuning (PEFT) minimizes the number of parameters that need to be updated during fine-tuning, making it efficient for resource-constrained scenarios. In multi-task learning, the model is trained on multiple related tasks simultaneously to improve generalization and capture common patterns across different domains. Reinforcement learning uses reward systems to guide the model's learning process and fine-tune its behavior toward optimal decision-making in specific scenarios. Regularization techniques such as dropout or L1/L2 regularization can be used to prevent overfitting and improve model stability during fine-tuning. In instruction fine-tuning, the model is trained using explicit instructions and examples to guide its responses for a particular task. Prompt engineering uses carefully crafted prompts to steer the LLM toward generating the desired output for the specific task. Few-shot learning fine-tunes the model with a limited number of examples to adapt to new tasks quickly.

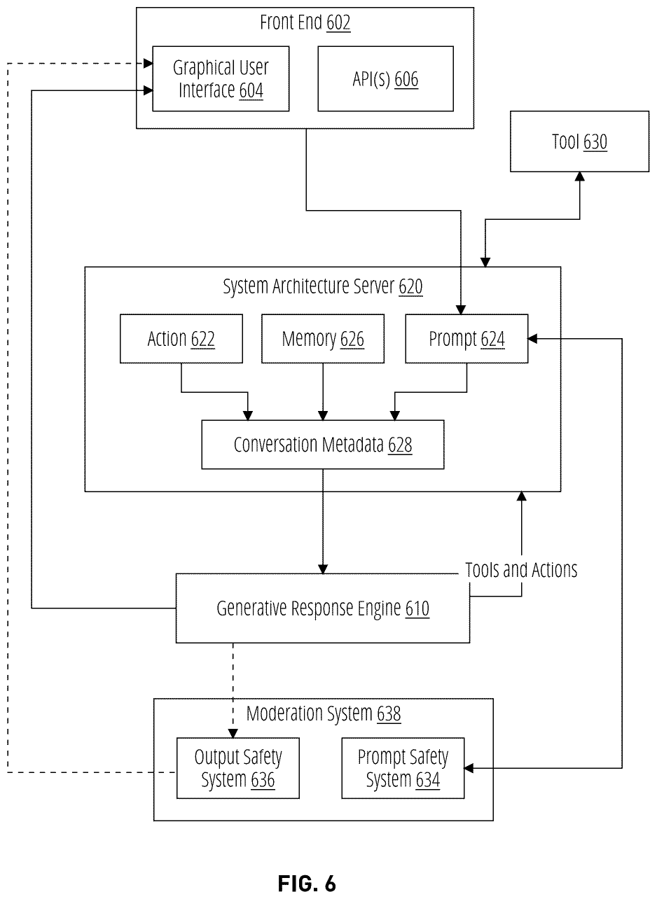

FIG. 6 illustrates an example system supporting a generative response engine during inference operations in accordance with some embodiments of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

The generative response engine 610 is an artificial intelligence (AI) that can generate content in response to a prompt. The prompt can be from a human or a software entity (AI or applications). The prompt is generally in natural language but could be in code, including binary. Some examples of the generative response engine can include language models that generate language, such as CHATGPT, or other models, such as DALL-E, which generates images, and SORA, which generates videos. CHATGPT, DALL-E, and SORA are all provided by OPENAI, but the generative response engine is not limited to AI provided by OPENAI. The generative response engine can also be any type of generative AI and can include AI developed using various architectures such as diffusion models and transformers (e.g., a generative pre-trained transformer) and combinations of models.

In some instances, a language model, such as CHATGPT, can receive prompts to output images, video, code, applications, etc., which it can provide by interfacing with one or more other models, as will be addressed further herein.

Users and applications can interact with the generative response engine 610 through the front end 602. The front end 602 serves as the interface and intermediary between the user and the generative response engine. It encompasses the graphical user interface 604 and Application Programming Interfaces (APIs) 606 that facilitate communication, input processing, and output presentation. Generally, users interact through a graphical user interface 604 that often includes a conversational interface, and applications interact through the API 606, but this is not a requirement.

The graphical user interface 604 is the platform through which users interact with the generative response engine 610. It can be a web-based chat window, a mobile application, or any interface that supports data input and output. The graphical user interface 604 facilitates a conversation between the user and the generative response engine, as the user provides prompts in the graphical user interface 604 to which the generative response engine responds and presents those responses in the graphical user interface 604. In some embodiments, graphical user interface 604 presents a conversational interface, which has attributes of a conversation thread between a user account and generative response engine 610.

The graphical user interface 604 is configured to perform input handling, context management, and output presentation. The type of inputs that can be received can be relative to the specifics of the generative response engine 610. But even when a model doesn't directly accept certain types of inputs, the front end 602 might be able to receive different types of inputs, which can be converted to inputs that are accepted by the generative response engine 610. For example, a language model is generally configured to accept text, but the front end 602 can accept voice and convert it to text or accept an image and create a textual representation.

The graphical user interface 604 is also configured to maintain the context of the conversation, which allows for coherent and relevant responses. For example, the graphical user interface 604 is responsible for providing the conversation thread and other relevant context accessible to the front end 602 to the generative response engine along with the specific prompt to the generative response engine. In an example, a conversation between the user account and the generative response engine 610 can have taken several turns (prompt, response, prompt, response, etc.). When the user account provides a further prompt, the graphical user interface 604 can provide that prompt to the generative response engine in the context of the entire conversation.

In another example, the front end 602 might have access to a memory 626 where facts about the user account have been stored. In some embodiments, these facts can have been identified as facts worth storing by the generative response engine and the front end 602 has stored these facts at the direction of the generative response engine. Accordingly, these facts can be provided to the generative response engine 610 along with a user-provided prompt so that the generative response engine has access to these facts when generating a response.

In another example, the graphical user interface 604 might be configured to provide a system prompt along with a user-provided prompt. A system prompt is hidden from the user account and is used to set the behavior and guidelines for the generative response engine. It can be used to define the AI's persona, style, and constraints.

The graphical user interface 604 is also configured to display the responses from the generative response engine, which might include text, code snippets, images, or interactive elements.

In some embodiments, the generative response engine 610 can provide instructions to the front end 602 that instruct the graphical user interface 604 about how to display some of the output from the generative response engine. For example, the generative response engine can direct the graphical user interface 604 to present code in a code-specific format, or to present interactive graphics, or static images. In other examples, the generative response engine can direct the graphical user interface 604 to present an interactive document editor where the graphical user interface 604 can be presented with the document editor so that the user account and the generative response engine can collaborate on the document. In some embodiments, the generative response engine 610 can provide instructions to the front end 602 to record facts in a personalization notepad. Accordingly, the graphical user interface 604 does not always display all of the output of the generative response engine.

As noted above, the front end 602 can also provide one or more application programming interfaces (API(s)) 606. APIs enable developers to integrate the generative response engine's capabilities into external applications and services. They provide programmatic access to the generative response engine, allowing for customized interactions and functionalities.

The APIs 606 can accept structured requests containing prompts, context, and configuration parameters. For example, an API can be used to provide prompts and divide the prompt into system prompts and user prompts. In some embodiments, the APIs 606 can provide specific inputs for which the generative response engine 610 is configured to respond with a specific behavior. For example, an API can be used to specify that it requires an output in a particular format or structured output. For example, in the chat completion API, the API call can specify parameters for the output, such as the max length for the desired output, and specify aspects of the tone of the language used in the response. Some common APIs are for participating in a conversation (Chat Completion API), for providing a single response (Completion API), for converting text into embeddings (Embeddings API), etc. The API can also be used to indicate specific decision boundaries that the generative response engine 610 might be trained to interpret. For example, the moderation API can take advantage of the generative response engine's content moderation decision-making. In the case of the moderation API and others, the API might give access to services other than the generative response engine. For example, the moderation API might be an interface to moderation system 638, addressed below.

Some other common APIs include the Fine-Tuning API, which allows developers to customize models of the generative response engine using their own datasets; the Audio and Speech APIs, which cause the generative response engine to output speech or audio; and the Image Generation API, which causes the generative response engine to output images (which might require utilizing other models).

There can also be APIs that direct the generative response engine to interface with other applications or other generative AI engines. In such cases, the specific application or AI engine might be specified, or the generative response engine might be allowed to choose another application of AI engine to utilize in response to a prompt.

In short, the graphical user interface 604 and the APIs 606 can be used to provide prompts to the generative response engine. Prompts are sometimes differentiated into prompt types. For example, a system prompt can be a hidden prompt that sets the behavior and guidelines for the generative response engine. A user prompt is the explicit input provided by the user, which may include questions, commands, or information.

Sitting in between front end 602 and generative response engine 610 is a system architecture server 620. The function of system architecture server 620 is to manage and organize the flow of data among key subsystems, enabling the generative response engine 610 to generate responses that are contextually relevant, accurate, and enriched with additional information as required.

Action 622 facilitates auxiliary tasks that extend beyond basic text generation. In some embodiments, action 622 can be actions that correspond to an API 606. In some embodiments, action 622 can be agentic actions that the generative response engine 610 decides to take to carry out a user's intent as described in the prompt.

Prompt 624 is the request or command provided by the user account through front end 602. In some embodiments, prompt 624 can be further supplemented by a system prompt and other information that might be included by graphical user interface 604 or API 606. In some embodiments, prompt 624 can even be modified or enhanced by generative response engine 610 as addressed further below. Additionally, as the user account provides prompts and generative response engine 610 provides responses, a conversation thread forms. As the user account provides a new prompt, this is appended to the overall conversation and added to prompt 624. Thus, a user account might think of a first user-provided message as a first prompt and a second user-provided message as a second prompt, and so on, but prompt 624 as perceived by generative response engine 610 can include a thread of user-provided messages and responses from generative response engine 610 in a multi-turn conversation. Generally, prompt 624 will include an entire conversation thread, but in some instances, prompt 624 might need to be shortened if it exceeds a maximum accepted length (generally measured by a number of tokens).

System architecture server 620 can also route prompts and response through moderation system 638, which can be separate or part of system architecture server 620. In some embodiments, prompts are provided to prompt safety system 634 before being provided to generative response engine 610. Prompt safety system 634 is configured to use one or more techniques to evaluate prompts to ensure a prompt is not requesting generative response engine 610 to generate moderated content. In some embodiments, prompt safety system 634 can utilize text pattern matching, classifiers, and/or other AI techniques.

Since prompts can evolve over time through the course of a conversation, consisting of prompts and responses, prompts can be repeatedly evaluated at each turn in the conversation.

Memory 626 can facilitate continuity and personalization in conversations. It allows the system to maintain user-specific context, preferences, or details that may inform future interactions. A memory file can be persisted data from previous interactions or sessions that provide background information to maintain continuity. In some embodiments, memory can be recorded at the instruction of generative response engine 610 when generative response engine 610 identifies a fact or data that it determines should be saved in memory because it might be useful in later conversations or sessions.

Conversation metadata 628 can aggregate data points relevant to the conversation, including user prompt 624, action 622, and memory 626. This consolidated information package serves as the input for generative response engine 610. Conversation metadata 628 can label parts of a prompt as user provided, generative response engine provided, a system prompt, memory 626, data from action 622 or tool 630 (addressed below).

The generative response engine is the core engine that processes inputs (from system architecture server 620) and generates outputs. In some embodiments, the generative response engine is a Generative Pre-trained Transformer (GPT), but it could utilize other architectures.

A core feature of the generative response engine 610 is to generate content in response to prompts. When the generative response engine 610 is a GPT, it is configured to receive inputs from front end 602 that provide guidance on a desired output. The generative response engine can analyze the input and identify relevant patterns and associations in the data, and it has learned to generate a sequence of tokens that are predicted as the most likely continuation of the input. The generative response engine 610 generates responses by sampling from the probability distribution of possible tokens, guided by the patterns observed during its training. In some embodiments, the generative response engine 610 can generate multiple possible responses before presenting the final one. The generative response engine 610 can generate multiple responses based on the input, and these responses are variations that the generative response engine 610 considers potentially relevant and coherent.

In some embodiments, the generative response engine 610 can evaluate generated responses based on certain criteria. These criteria can include relevance to the prompt, coherence, fluency, and sometimes adherence to specific guidelines or rules, depending on the application. Based on this evaluation, the generative response engine 610 can select the most appropriate response. This selection is typically the one that scores highest on the set criteria, balancing factors like relevance, informativeness, coherence, and content moderation instructions/training.

In some embodiments, an instruction provided by an API 606, a system prompt, or a decision made by generative response engine 610 can cause the generative response engine 610 to interpret a prompt and re-write it or improve the prompt for a desired purpose. For example, generative response engine 610 can determine to take a prompt to make a picture and enhance the prompt to yield a better picture. In these instances, generative response engine 610 can generate its own prompts, which can be provided to a tool 630 or provided to generative response engine 610 to yield a better output response than the original prompt might have.

The generative response engine 610 can also do more than generate content in response to a prompt. In some embodiments, the generative response engine 610 can utilize decision boundaries to determine the appropriate course of action based on the prompt. In some examples, a decision boundary might be used to cause the generative response engine to recognize that it is being asked to provide a response in a particular format such that it will generate its response constrained by the particular format. In some examples, a decision boundary can cause the model to refuse to generate a responsive output if the decision is that the responsive output would violate a moderation policy. In some examples, the decision boundary might cause the generative response engine to recognize that it needs to interface with another AI model or application to respond to the prompt. For example, when the generative response engine is a language model, it might recognize that it is being asked to output an image, and therefore, it needs to interface with a model that can output images to provide a response to the prompt. In another example, the prompt might request a search of the Internet before responding. The generative response engine can use a decision boundary to recognize that it should conduct a search of the Internet and use the results of that search in responding to the prompt. In another example, the prompt might request that the generative response engine take an agentic action on behalf of the user by interacting with a third-party service (e.g., book a reservation for me at . . . ) , and the generative response engine can utilize a decision boundary to recognize that it needs to plan steps to locate the third-party service, contact the third-party service, and interact with the third-party service to complete the task and then report back to the user that the action has been completed.

When generative response engine 610 determines that it should take an agentic action on behalf of the user or it should call a tool to aid in providing a quality response to the user account, the generative response engine 610 might call a tool 630 or cause an action 622 to be performed. As indicated above, tools 630 can include internet browsers, editors such as code editors, other AI tools etc. Actions 622 are actions that the generative response engine 610 can cause to be performed, perhaps using tool 630. As used herein actions 622 should be considered to cover a broad array of actions that generative response engine 610 can perform with or without tools 630. Tools 630 are considered to cover a wide variety of services and software that encompass tools such as a computer operating system such that the generative response engine 610 can control the computer operating system on the user's behalf, to robotic actuators, to search browsers and specific applications.

Additionally, the generative response engine 610 can also generate portions of responses that are not displayed to the user. For example, the generative response engine 610 can direct the front end 602 to provide specific behaviors, such as directions for how to present the response from the generative response engine 610 to the user account. In another example, the generative response engine 610 can provide response portions dictated by an API, where portions of the response to the API might be for the consumption of the calling application but not for presentation to the end user.

In some embodiments, the output of generative response engine can be further analyzed by output safety system 636. While generative response engine 610 can perform some of its own moderation, there can be instances where it is desired to have another service review outputs for compliance with the moderation policy. The use of dashed lines in FIG. 6 differentiates a path using output safety system 636 and not using output safety system 636.

While FIG. 6 shows responses being provided back to front end 602 directly, in some embodiments, the responses might be returned by way of system architecture server 620.

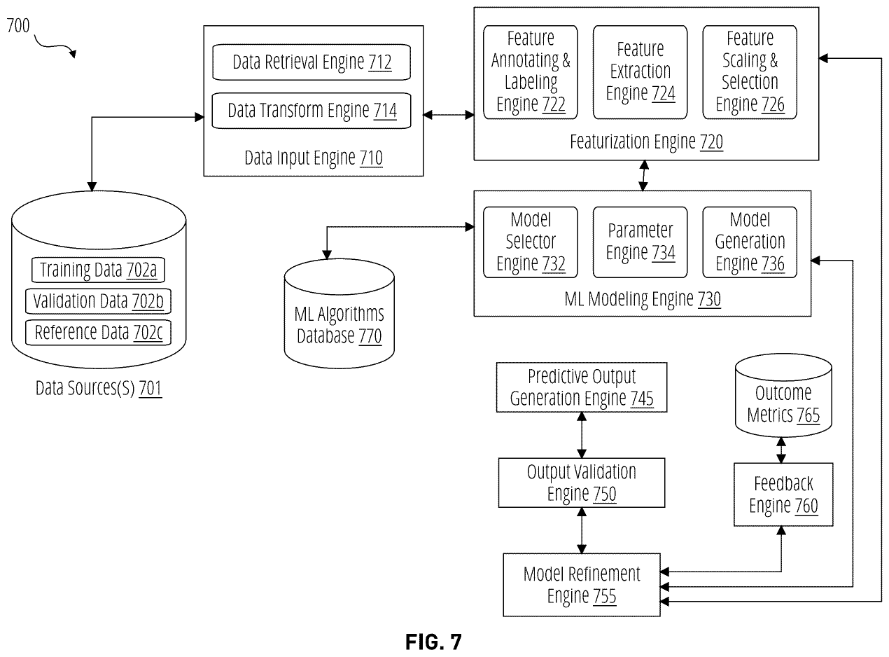

FIG. 7 is a block diagram illustrating an example machine learning platform for implementing various aspects of this disclosure in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

System 700 may include data input engine 710 that can further include data retrieval engine 712 and data transform engine 714. Data retrieval engine 712 may be configured to access, interpret, request, or receive data, which may be adjusted, reformatted, or changed (e.g., to be interpretable by another engine, such as data input engine 710). For example, data retrieval engine 712 may request data from a remote source using an API. Data input engine 710 may be configured to access, interpret, request, format, re-format, or receive input data from data sources(s) 701. For example, data input engine 710 may be configured to use data transform engine 714 to execute a re-configuration or other change to data, such as a data dimension reduction. In some embodiments, data sources(s) 701 may be associated with a single entity (e.g., organization) or with multiple entities. Data sources(s) 701 may include one or more of training data 702a (e.g., input data to feed a machine learning model as part of one or more training processes), validation data 702b (e.g., data against which at least one processor may compare model output with, such as to determine model output quality), and/or reference data 702c. In some embodiments, data input engine 710 can be implemented using at least one computing device. For example, data from data sources(s) 701 can be obtained through one or more I/O devices and/or network interfaces. Further, the data may be stored (e.g., during execution of one or more operations) in a suitable storage or system memory. Data input engine 710 may also be configured to interact with a data storage, which may be implemented on a computing device that stores data in storage or system memory.

System 700 may include featurization engine 720. Featurization engine 720 may include feature annotating & labeling engine 722 (e.g., configured to annotate or label features from a model or data, which may be extracted by feature extraction engine 724), feature extraction engine 724 (e.g., configured to extract one or more features from a model or data), and/or feature scaling & selection engine 726 Feature scaling & selection engine 726 may be configured to determine, select, limit, constrain, concatenate, or define features (e.g., AI features) for use with AI models.

System 700 may also include machine learning (ML) ML modeling engine 730, which may be configured to execute one or more operations on a machine learning model (e.g., model training, model re-configuration, model validation, model testing), such as those described in the processes described herein. For example, ML modeling engine 730 may execute an operation to train a machine learning model, such as adding, removing, or modifying a model parameter. Training of a machine learning model may be supervised, semi-supervised, or unsupervised. In some embodiments, training of a machine learning model may include multiple epochs, or passes of data (e.g., training data 702a) through a machine learning model process (e.g., a training process). In some embodiments, different epochs may have different degrees of supervision (e.g., supervised, semi-supervised, or unsupervised). Data into a model to train the model may include input data (e.g., as described above) and/or data previously output from a model (e.g., forming a recursive learning feedback). A model parameter may include one or more of a seed value, a model node, a model layer, an algorithm, a function, a model connection (e.g., between other model parameters or between models), a model constraint, or any other digital component influencing the output of a model. A model connection may include or represent a relationship between model parameters and/or models, which may be dependent or interdependent, hierarchical, and/or static or dynamic. The combination and configuration of the model parameters and relationships between model parameters discussed herein are cognitively infeasible for the human mind to maintain or use. Without limiting the disclosed embodiments in any way, a machine learning model may include millions, billions, or even trillions of model parameters. ML modeling engine 730 may include model selector engine 732 (e.g., configured to select a model from among a plurality of models, such as based on input data), parameter engine 734 (e.g., configured to add, remove, and/or change one or more parameters of a model), and/or model generation engine 736 (e.g., configured to generate one or more machine learning models, such as according to model input data, model output data, comparison data, and/or validation data).

In some embodiments, model selector engine 732 may be configured to receive input and/or transmit output to ML algorithms database 770. Similarly, featurization engine 720 can utilize storage or system memory for storing data and can utilize one or more I/O devices or network interfaces for transmitting or receiving data. ML algorithms database 770 may store one or more machine learning models, any of which may be fully trained, partially trained, or untrained. A machine learning model may be or include, without limitation, one or more of (e.g., such as in the case of a metamodel) a statistical model, an algorithm, a neural network (NN), a convolutional neural network (CNN), a generative neural network (GNN), a Word2Vec model, a bag of words model, a term frequency-inverse document frequency (tf-idf) model, a GPT (Generative Pre-trained Transformer) model (or other autoregressive model), a diffusion model, a diffusion-transformer model, an encoder such as BERT (Bidirectional Encoder Representations from Transformers) or LXMERT (Learning Cross-Modality Encoder Representations from Transformers), a Proximal Policy Optimization (PPO) model, a nearest neighbor model (e.g., k nearest neighbor model), a linear regression model, a k-means clustering model, a Q-Learning model, a Temporal Difference (TD) model, a Deep Adversarial Network model, or any other type of model described further herein. Some of the ML algorithms in ML algorithms database 770 can be considered generative response engines.

Generative response engines are those models are commonly referred to as Generative AI, and that can receive an input prompt and generate additional content based on the prompt. GPTs, diffusion models, and diffusion-transformer models are some non-limiting examples of generative response engines. Some specific examples of generative response engines that can be stored in the ML algorithms database 770 include versions DALL⋅E, CHAT GPT, and SORA, all provided by OPEN AI.

System 700 can further include predictive output generation engine 745 and output validation engine 750 (e.g., configured to apply validation data to machine learning model output). Predictive output generation engine 745 can analyze the input and identify relevant patterns and associations in the data it has learned to generate a sequence of words that predictive output generation engine 745 predicts is the most likely continuation of the input using one or more models from the ML algorithms database 770, aiming to provide a coherent and contextually relevant answer. Predictive output generation engine 745 generates responses by sampling from the probability distribution of possible words and sequences, guided by the patterns observed during its training. In some embodiments, predictive output generation engine 745 can generate multiple possible responses before presenting the final one. Predictive output generation engine 745 can generate multiple responses based on the input, and these responses are variations that predictive output generation engine 745 considers potentially relevant and coherent. Output validation engine 750 can evaluate these generated responses based on certain criteria. These criteria can include relevance to the prompt, coherence, fluency, and sometimes adherence to specific guidelines or rules, depending on the application. Based on this evaluation, output validation engine 750 selects the most appropriate response. This selection is typically the one that scores highest on the set criteria, balancing factors like relevance, informativeness, and coherence.

System 700 can further include feedback engine 760 (e.g., configured to apply feedback from a user and/or machine to a model) and model refinement engine 755 (e.g., configured to update or re-configure a model). In some embodiments, feedback engine 760 may receive input and/or transmit output (e.g., output from a trained, partially trained, or untrained model) to outcome metrics database 765. Outcome metrics database 765 may be configured to store output from one or more models and may also be configured to associate output with one or more models. In some embodiments, outcome metrics database 765, or other device (e.g., model refinement engine 755 or feedback engine 760), may be configured to correlate output, detect trends in output data, and/or infer a change to input or model parameters to cause a particular model output or type of model output. In some embodiments, model refinement engine 755 may receive output from predictive output generation engine 745 or output validation engine 750. In some embodiments, model refinement engine 755 may transmit the received output to featurization engine 720 or ML modeling engine 730 in one or more iterative cycles.

The engines of system 700 may be packaged functional hardware units designed for use with other components or a part of a program that performs a particular function (e.g., of related functions). Any or each of these modules may be implemented using a computing device. In some embodiments, the functionality of system 700 may be split across multiple computing devices to allow for distributed processing of the data, which may improve output speed and reduce computational load on individual devices. In some embodiments, system 700 may use load-balancing to maintain stable resource load (e.g., processing load, memory load, or bandwidth load) across multiple computing devices and to reduce the risk of a computing device or connection becoming overloaded. In these or other embodiments, the different components may communicate over one or more I/O devices and/or network interfaces.

System 700 can be related to different domains or fields of use. Descriptions of embodiments related to specific domains, such as natural language processing or language modeling, is not intended to limit the disclosed embodiments to those specific domains, and embodiments consistent with the present disclosure can apply to any domain that utilizes predictive modeling based on available data.

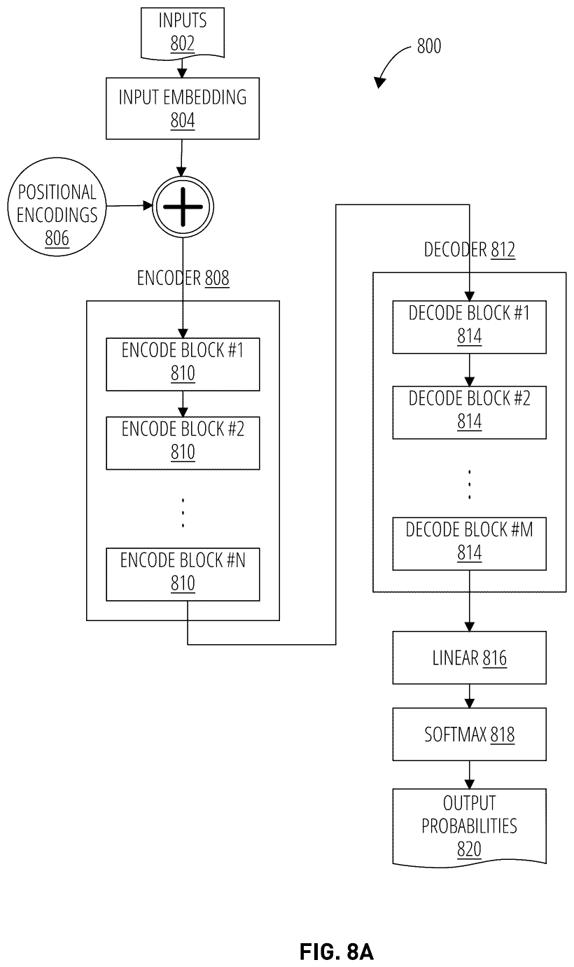

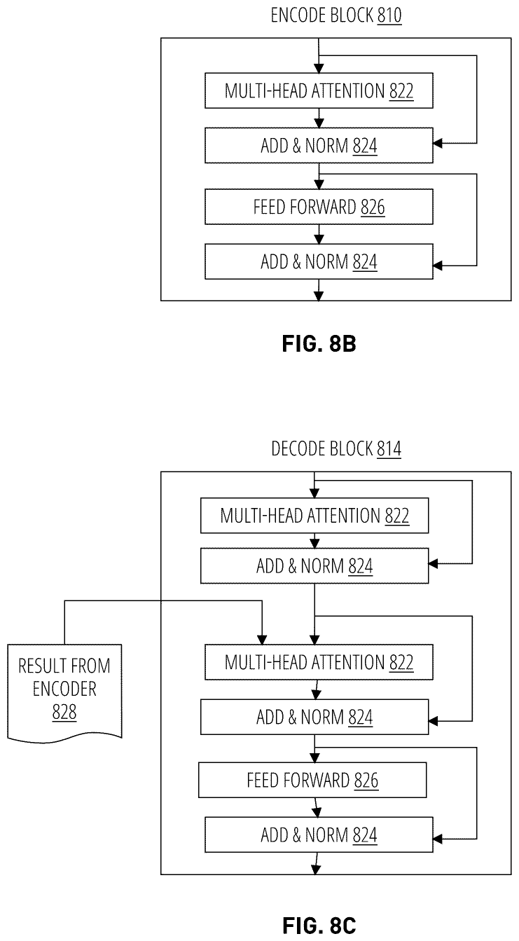

FIG. 8A, FIG. 8B, and FIG. 8C illustrates an example transformer architecture in accordance with some embodiments of the present technology. Examples of ML models that use a transformer neural network (e.g., transformer architecture 800) can include, e.g., generative pretrained transformer (GPT) models and Bidirectional Encoder Representations from Transformer (BERT) models. The transformer architecture 800, which is illustrated in FIG. 8A, FIG. 8B, and FIG. 8C, includes inputs 802, input embedding block 804, positional encodings 806, encoder 808 including encode blocks 810, decoder 812 including decode blocks 814, linear block 816, softmax block 818, and output probabilities 820.

Input embedding block 804 is used to provide representations for words. For example, embedding can be used in text analysis. According to certain non-limiting examples, the representation is a real-valued vector that encodes the meaning of the word in such a way that words that are closer in the vector space are expected to be similar in meaning. Word embeddings can be obtained using language modeling and feature learning techniques, where words or phrases from the vocabulary are mapped to vectors of real numbers. According to certain non-limiting examples, the input embedding block 804 can be learned embeddings to convert the input tokens and output tokens to vectors of dimension that have the same dimension as the positional encodings, for example.

Positional encodings 806 provide information about the relative or absolute position of the tokens in the sequence. According to certain non-limiting examples, positional encodings 806 can be provided by adding positional encodings to the input embeddings at the inputs to the encoder 808 and decoder 812. The positional encodings have the same dimension as the embeddings, thereby enabling a summing of the embeddings with the positional encodings. There are several ways to realize the positional encodings, including learned and fixed. For example, sine and cosine functions having different frequencies can be used. That is, each dimension of the positional encoding corresponds to a sinusoid. Other techniques of conveying positional information can also be used, as would be understood by a person of ordinary skill in the art. For example, learned positional embeddings can instead be used to obtain similar results. An advantage of using sinusoidal positional encodings rather than learned positional encodings is that doing so allows the model to extrapolate to sequence lengths longer than the ones encountered during training.

Encoder 808 can use stacked self-attention and point-wise, fully connected layers. Encoder 808 can be a stack of N identical layers (e.g., N=6), and each layer can be an encode block, as illustrated by encode block 810 shown in FIG. 8B. Each encode block 810 has two sub-layers: (i) a first sub-layer has a multi-head attention block 822 and (ii) a second sub-layer has a feed forward block 826, which can be a position-wise fully connected feed-forward network. The feed forward block 826 can use a rectified linear unit (ReLU).

Encoder 808 uses a residual connection around each of the two sub-layers, followed by an add & norm block 824, which performs normalization. For example, the output of each sub-layer can be LayerNorm(x+Sublayer(x)). To facilitate these residual connections, all sub-layers in the model, as well as the embedding layers, produce output data having a same dimension.

Similar to encoder 808, decoder 812 uses stacked self-attention and point-wise, fully connected layers. Decoder 812 can also be a stack of M identical layers (e.g., M=6), and each layer can be a decode block, as illustrated by decode block 812 shown in FIG. 8B. In addition to the two sub-layers (i.e., the sublayer with multi-head attention block 822 and the sub-layer with feed forward block 826) found in encode block 810, decode block 814 can include a third sub-layer, which performs multi-head attention over the output of the encoder stack. Similar to encoder 808, decoder 812 uses residual connections around each of the sub-layers, followed by layer normalization. Additionally, the sub-layer with multi-head attention block 822 can be modified in the decoder stack to prevent positions from attending to subsequent positions. This masking, combined with the fact that the output embeddings are offset by one position, can ensure that the predictions for position i can depend only on the known output data at positions less than i.

Linear block 816 can be a learned linear transformation. For example, when transformer architecture 800 is being used to translate from a first language into a second language, linear block 816 can project the output from the last decode softmax block 818 into word scores for the second language (e.g., a score value for each unique word in the target vocabulary) at each position in the sentence. For instance, if the output sentence has seven words and the provided vocabulary for the second language has 10,000 unique words, then 10,000 score values are generated for each of those seven words. The score values indicate the likelihood of occurrence for each word in the vocabulary in that position of the sentence.

Softmax block 818 then turns the scores from linear block 816 into output probabilities 820 (which add up to 1.0). In each position, the index provides for the word with the highest probability, and then maps that index to the corresponding word in the vocabulary. Those words then form the output sequence of transformer architecture 800. The softmax operation is applied to the output from linear block 816 to convert the raw numbers into output probabilities 820 (e.g., token probabilities).

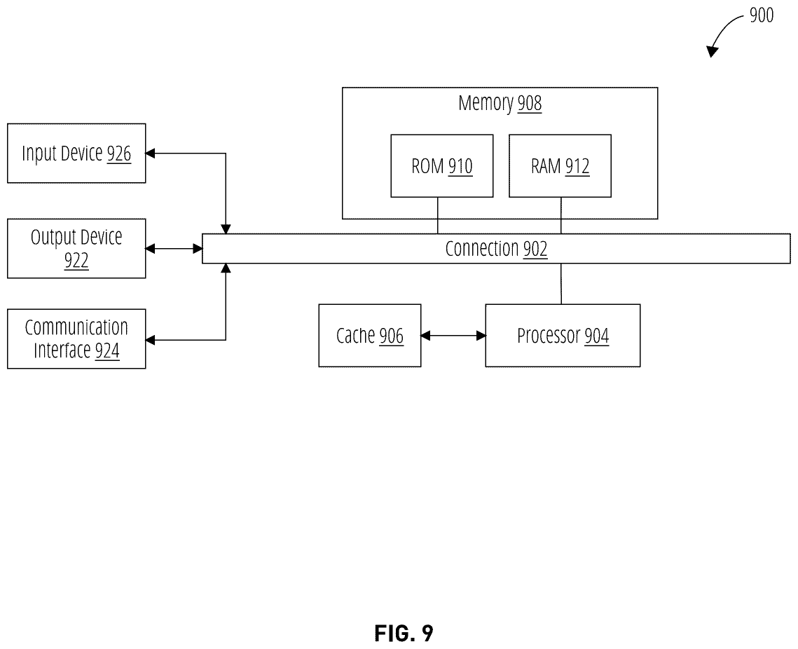

FIG. 9 shows an example of computing system 900, which can be, for example, any computing device making up any inference engine, controller, or other component of system 100 or illustrated in FIG. 1A and/or network system 300 illustrated FIG. 3 or any component thereof. Further, computing system 900 can be any computing device performing any of the steps or processes of method 400 illustrated in FIG. 4 or any component thereof.

In some embodiments, computing system 900 is a single device, or a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

In some embodiments, computing system 900 may comprise one or more computing resources provisioned from a “cloud computing” provider, for example, AMAZON ELASTIC COMPUTE CLOUD (“AMAZON EC2”), provided by AMAZON, INC. of Seattle, Washington; SUN CLOUD COMPUTER UTILITY, provided by SUN MICROSYSTEMS, INC. of Santa Clara, California; AZURE, provided by MICROSOFT CORPORATION of Redmond, Washington, GOOGLE CLOUD PLATFORM, provided by ALPHABET, INC. of Mountain View, California, and the like.

Example computing system 900 includes at least one processing unit (CPU or processor) 904 and connection 902 that couples various system components including system memory 908, such as read-only memory (ROM) 910 and random access memory (RAM) 912 to processor 904. Memory 908 can be a volatile or non-volatile memory device, and can be a hard disk or other types of non-transitory computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

Memory 908 can include software services, servers, logic, etc., that when the code that defines such software is executed by the processor 904, it causes the system to perform a function. In some embodiments, a hardware service that performs a particular function can include the software component stored in a computer-readable medium in connection with the necessary hardware components, such as processor 904, connection 902, output device 922, etc., to carry out the function.

Computing system 900 can include a cache of high-speed memory 906 connected directly with, in close proximity to, or integrated as part of processor 904.

Connection 902 can be a physical connection via a bus, or a direct connection into processor 904, such as in a chipset architecture. Connection 902 can also be a virtual connection, networked connection, or logical connection.

Processor 904 can include any general-purpose processor and a hardware service or software service stored in memory 908, configured to control processor 904 as well as a special-purpose processor where software instructions are incorporated into the actual processor design. Processor 904 may essentially be a completely self-contained computing system, containing multiple cores or processors, a bus, memory controller, cache, etc. A multi-core processor may be symmetric or asymmetric. Processor 904 can be physical or virtual.

To enable user interaction, computing system 900 includes an input device 926, which can represent any number of input mechanisms, such as a microphone for speech, a touch-sensitive screen for gesture or graphical input, keyboard, mouse, motion input, speech, etc. Computing system 900 can also include output device 922, which can be one or more of a number of output mechanisms known to those of skill in the art. In some instances, multimodal systems can enable a user to provide multiple types of input/output to communicate with computing system 900. Computing system 900 can include communication interface 924, which can generally govern and manage the user input and system output. There is no restriction on operating on any particular hardware arrangement, and therefore the basic features here may easily be substituted for improved hardware or firmware arrangements as they are developed.

In some embodiments, computing system 900 can refer to a combination of a personal computing device interacting with components hosted in a data center, where both the computing device and the components in the data center. In such examples, both the personal computing device and the components in the datacenter might have a processor, cache, memory, storage, etc.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

### Aspects

The present technology includes computer-readable storage mediums for storing instructions, and systems for executing any one of the methods embodied in the instructions addressed in the aspects of the present technology presented below:

Aspect 1. A method, comprising: receiving, at a generative response system, a plurality of requests to generate responses based on respective fine-tuned models; organizing the plurality of requests into first requests and second requests based on which requests of the plurality of requests use currently-loaded fine-tuned models that are on one or more inference engines of the generative response system when the plurality of requests are received; and processing the first requests; and processing the second requests, after processing the first requests.

Aspect 2. The method of aspect 1, wherein: an inference engine of the one or more inference engines comprises a plurality of graphics processing units (GPUs) having GPU memory, the inference engine is associated with another memory on the generative response system, and the respective fine-tuned models are low order rank adapters (LoRAs) model, and a LoRA model is loaded on the inference engine by: storing base weights of a base model on which the LoRA model is generated in a first space of the GPU memory that has been allocated for storing base models, and storing LoRA weights of the LoRA model in second space of the GPU memory that has been allocated for storing LoRA models, and a third space of the GPU memory is allocated as key-value (KV) cache.

Aspect 3. The method of aspect 2, wherein the another memory is random access memory (RAM) on the generative response system that is connected via a bus to the inference engine.

Aspect 4. The method of any of aspects 1-3, wherein processing the second requests includes: loading, onto the one or more inference engines, a requested fine-tuned model that is requested to process one or more of the second requests.

Aspect 5. The method of aspect 4, wherein processing the second requests includes: fetching the requested fine-tuned model according to a caching hierarchy that includes one or more first memories on the one or more inference engines, one or more second memories that are in the generative response system, and a third memory connected via a network to the generative response system, wherein when the requested fine-tuned model is in the one or more second memories, the requested fine-tuned model is fetched from the one or more second memories, rather than being fetched from the third memory.

Aspect 6. The method of aspect 5, wherein a selected model of the currently-loaded fine-tuned models that are on the one or more inference engines is replaced by the requested fine-tuned model.

Aspect 7. The method of aspect 6, wherein: the one or more inference engines respectively have a first memory of one or more first memories, the first memory of an inference engine of the one or more inference engines includes a first space storing base weights, a second space storing fine-tuned weights, and a third space allocated for key-value (KV) cache, and the requested fine-tuned model is loaded in the inference engine by writing fine-tuned weights of the requested fine-tuned model to the second space of the first memory of the inference engine.

Aspect 8. The method of aspect 7, further comprising: dynamically allocating a part of the first memory between the second space and the third space on a first inference engine of the one or more inference engines, wherein the part of the first memory is dynamically allocated based on a frequency with which inference engines are loaded on the first inference engine.

Aspect 9. The method of aspect 6, wherein the selected model is selected based on having been unused for a longer time than other models of the currently-loaded fine-tuned models.

Aspect 10. The method of aspect 9, further comprising: maintaining, in the one or more second memories, the selected model after the selected model is no longer on the one or more inference engines.

Aspect 11. The method of aspect 9, wherein processing the second requests includes: fetching the requested fine-tuned model from the third memory, when the requested fine-tuned model is not in the one or more second memories, wherein fetching the requested fine-tuned model from the third memory includes: replacing another fine-tuned model on the one or more second memories with the requested fine-tuned model, copying the requested fine-tuned model from the one or more second memories to a fine-tuned-weights space on a first memory of the one or more first memories to replace the selected model, and selecting the another fine-tuned model that is replaced on the one or more second memories by the requested fine-tuned model based on a lack of use of the another fine-tuned model for processing requests to the generative response system.

Aspect 12. The method of any of aspects 1-11, further comprising: batching a set of requests of the first request to be processed in parallel, wherein the set of requests each request a same fine-tuned model; preventing a request of the second requests form reaching a front of a queue of an inference engine onto which a requested fine-tuned model corresponding to the request is being loaded by holding the request out of the queue while the requested fine-tuned model is being loaded onto the inference engine; and prioritizing processing of remaining requests of the plurality of requests for which processing has been delayed by more than a predefined period to mitigate requests having a large processing latency.

Aspect 13. The method of any of aspects 1-12, wherein: the one or more inference engines include a first inference engine and a second inference engine each having a same fine-tuned model loaded thereon, and the method further comprising load balancing requests among the one or more inference engines by sending a request of the plurality of requests that is for the same fine-tuned model to one of the first inference engine and the second inference engine having fewer requests in a queue.

Aspect 14. The method of any of aspects 1-13, wherein: the one or more inference engines include a first inference engine having a first number of requests in a first queue and a second inference engine having a second number of requests in a second queue, the first number of requests being greater than the second number of requests, a request of the plurality of requests requesting a first fine-tuned model that is loaded on the first inference engine and is not loaded on the second inference engine, and the method further comprising load balancing requests among the one or more inference engines by: analyzing a combination of the first number of requests, the second number of requests, and a process for loading the first fine-tuned model on the second inference engine to generate an analysis result, and determining, based on the analysis result, whether to send the request to the first queue of the first fine-tuned model or to load the first fine-tuned model on the second inference engine and send the request to the second queue of the second fine-tuned model.

Aspect 15. The method of aspect 14, wherein analyzing a combination of the first number of requests, the second number of requests, and the process for loading the first fine-tuned model includes: determining a first time associated with the first number of requests being processed by the first inference engine, determining a second time associated with the second number of requests being processed by the second inference engine, analyzing where the first fine-tuned model is in a caching hierarchy of the second inference engine, and determining, based on the caching hierarchy, a third time associated with loading the first fine-tuned model on the second inference engine.

Aspect 16. A method, comprising: receiving, at a generative response system, a plurality of requests to generate respective responses corresponding to prompts of respective requests of the plurality of requests, a request of the plurality of requests including a prompt and a model identifier indicating an inference model that is requested to generate a response to the prompt, wherein the inference model is a base model comprising base weights or a fine-tuned model that is a fine-tuned version of the base model, the fine-tuned model comprising fine-tuned weights and the base weights; processing, by one or more inference engines of the generative response system, the plurality of requests to generate a plurality of responses; and organizing, by the generative response system, the plurality of requests into first requests and second requests, wherein the first requests respectively request current inference models that are loaded on the one or more inference engines when the plurality of requests are received, and the second requests respectively request other inference models that are not loaded on the one or more inference engines when the plurality of requests are received, wherein the generative response system processes the first requests before processing the second requests.

Aspect 17. The method of aspect 16, further comprising: storing, at the generative response system, a plurality of fine-tuned inference models on the one or more inference engines, wherein an inference engine of the one or more inference engines includes a plurality of processors having a first memory storing a first set of models of the plurality of fine-tuned inference models, and a first part of the first memory stores base weights of a first base model of the first set of models, a second part of the first memory stores fine-tuned weights of the first set of inference models, and a third part of the first memory is allocated as key-value (KV) cache; loading, on the inference engine, a requested fine-tuned model that is requested by one of the second requests by writing fine-tuned weights of the fine-tuned model in the second part of the first memory; and processing, by the inference engine, the one of the second requests, after the requested fine-tuned model has been loaded, wherein when the inference engine lacks free space in the second space of the first memory, the fine-tuned weights of the requested fine-tuned model replace fine-tuned weights of a selected fine-tuned model on the inference engine.

Aspect 18. A non-transitory computer readable medium comprising one or more sequences of instructions, which, when executed by a processor, cause a computing system associated with a content management system to perform operations of the method of any of aspects 1-17.

Aspect 19. A generative response system comprising: one or more processors; and a memory having programming instructions stored thereon, which, when executed by the one or more processors, causes the content management system to perform operations of the method of any of aspects 1-17.

What is claimed is:

1. A method, comprising:
receiving, at a generative response system, a plurality of requests to generate responses based on respective fine-tuned models;
organizing the plurality of requests into first requests and second requests based on which requests of the plurality of requests use currently-loaded fine-tuned models that are on one or more inference engines of the generative response system when the plurality of requests are received, wherein the first requests use the currently-loaded fine-tuned models and the second requests do no use the currently-loaded fine-tuned models; and
processing the first requests; and
processing the second requests, after processing the first requests.

2. The method of claim 1, wherein:
an inference engine of the one or more inference engines comprises a plurality of graphics processing units (GPUs) having GPU memory,
the inference engine is associated with another memory on the generative response system,
the respective fine-tuned models are low order rank adapters (LoRAs) model,
a LoRA model is loaded on the inference engine by:
storing base weights of a base model on which the LoRA model is generated in a first space of the GPU memory that has been allocated for storing base models, and
storing LoRA weights of the LoRA model in second space of the GPU memory that has been allocated for storing LoRA models, and
a third space of the GPU memory is allocated as key-value (KV) cache.

3. The method of claim 2, wherein the another memory is random access memory (RAM) on the generative response system that is connected via a bus to the inference engine.

4. The method of claim 1, wherein processing the second requests includes:
loading, onto the one or more inference engines, a requested fine-tuned model that is requested to process one or more of the second requests.

5. The method of claim 4, wherein processing the second requests includes:
fetching the requested fine-tuned model according to a caching hierarchy that includes one or more first memories on the one or more inference engines, one or more second memories that are in the generative response system, and a third memory connected via a network to the generative response system, wherein
when the requested fine-tuned model is in the one or more second memories, the requested fine-tuned model is fetched from the one or more second memories, rather than being fetched from the third memory.

6. The method of claim 5, wherein a selected model of the currently-loaded fine-tuned models that are on the one or more inference engines is replaced by the requested fine-tuned model.

7. The method of claim 6, wherein:
the one or more inference engines respectively have a first memory of one or more first memories,
the first memory of an inference engine of the one or more inference engines includes a first space storing base weights, a second space storing fine-tuned weights, and a third space allocated for key-value (KV) cache, and
the requested fine-tuned model is loaded in the inference engine by writing fine-tuned weights of the requested fine-tuned model to the second space of the first memory of the inference engine.

8. The method of claim 7, further comprising:
dynamically allocating a part of the first memory between the second space and the third space on a first inference engine of the one or more inference engines, wherein
the part of the first memory is dynamically allocated based on a frequency with which inference engines are loaded on the first inference engine.

9. The method of claim 6, wherein the selected model is selected based on having been unused for a longer time than other models of the currently-loaded fine-tuned models.

10. The method of claim 9, further comprising:
maintaining, in the one or more second memories, the selected model after the selected model is no longer on the one or more inference engines.

11. The method of claim 9, wherein processing the second requests includes:
fetching the requested fine-tuned model from the third memory, when the requested fine-tuned model is not in the one or more second memories, wherein fetching the requested fine-tuned model from the third memory includes:
replacing another fine-tuned model on the one or more second memories with the requested fine-tuned model,
copying the requested fine-tuned model from the one or more second memories to a fine-tuned-weights space on a first memory of the one or more first memories to replace the selected model, and
selecting the another fine-tuned model that is replaced on the one or more second memories by the requested fine-tuned model based on a lack of use of the another fine-tuned model for processing requests to the generative response system.

12. The method of claim 1, further comprising:
batching a set of requests of the first request to be processed in parallel, wherein the set of requests each request a same fine-tuned model;
preventing a request of the second requests form reaching a front of a queue of an inference engine onto which a requested fine-tuned model corresponding to the request is being loaded by holding the request out of the queue while the requested fine-tuned model is being loaded onto the inference engine; and
prioritizing processing of remaining requests of the plurality of requests for which processing has been delayed by more than a predefined period to mitigate requests having a large processing latency.

13. The method of claim 1, wherein:
the one or more inference engines include a first inference engine and a second inference engine each having a same fine-tuned model loaded thereon, and
the method further comprising load balancing requests among the one or more inference engines by sending a request of the plurality of requests that is for the same fine-tuned model to one of the first inference engine and the second inference engine having fewer requests in a queue.

14. The method of claim 1, wherein:
the one or more inference engines include a first inference engine having a first number of requests in a first queue and a second inference engine having a second number of requests in a second queue, the first number of requests being greater than the second number of requests,
a request of the plurality of requests requesting a first fine-tuned model that is loaded on the first inference engine and is not loaded on the second inference engine, and
the method further comprising load balancing requests among the one or more inference engines by:
analyzing a combination of the first number of requests, the second number of requests, and a process for loading the first fine-tuned model on the second inference engine to generate an analysis result, and
determining, based on the analysis result, whether to send the request to the first queue of the first fine-tuned model or to load the first fine-tuned model on the second inference engine and send the request to the second queue of the second fine-tuned model.

15. The method of claim 14, wherein analyzing a combination of the first number of requests, the second number of requests, and the process for loading the first fine-tuned model includes:
determining a first time associated with the first number of requests being processed by the first inference engine,
determining a second time associated with the second number of requests being processed by the second inference engine,
analyzing where the first fine-tuned model is in a caching hierarchy of the second inference engine, and
determining, based on the caching hierarchy, a third time associated with loading the first fine-tuned model on the second inference engine.

16. A generative response system comprising:
one or more processors, including one or more inference engines; and
a memory storing instructions that, when executed by the processor, configure the generative response system to:
receive a plurality of requests to generate responses based on respective fine-tuned models;
organize the plurality of requests into first requests and second requests based on which requests of the plurality of requests use currently-loaded fine-tuned models that are on the one or more inference engines of the generative response system when the plurality of requests are received, wherein the first requests use the currently-loaded fine-tuned models and the second requests do no use the currently-loaded fine-tuned models; and
process the first requests; and
process the second requests, after processing the first requests.

17. The generative response system of claim 16, wherein:
an inference engine of the one or more inference engines comprises a plurality of graphics processing units (GPUs) having GPU memory,
the inference engine is associated with another memory on the generative response system,
the respective fine-tuned models are low order rank adapters (LoRAs) model,
a LoRA model is loaded on the inference engine by:
storing base weights of a base model on which the LoRA model is generated in a first space of the GPU memory that has been allocated for storing base models, and
storing LoRA weights of the LoRA model in second space of the GPU memory that has been allocated for storing LoRA models, and
a third space of the GPU memory is allocated as key-value (KV) cache.

18. The generative response system of claim 16, wherein the generative response system processes the second requests by the instructions further configuring the generative response system to:
load, onto the one or more inference engines, a requested fine-tuned model that is requested to process one or more of the second requests; and
fetch the requested fine-tuned model according to a caching hierarchy that includes one or more first memories on the one or more inference engines, one or more second memories that are in the generative response system, and a third memory connected via a network to the generative response system, wherein
when the requested fine-tuned model is in the one or more second memories, the requested fine-tuned model is fetched from the one or more second memories, rather than being fetched from the third memory.

19. The generative response system of claim 16, wherein the instructions further configuring the generative response system to:
batch a set of requests of the first request to be processed in parallel, wherein the set of requests each request a same fine-tuned model;
prevent a request of the second requests form reaching a front of a queue of an inference engine onto which a requested fine-tuned model corresponding to the request is being loaded by holding the request out of the queue while the requested fine-tuned model is being loaded onto the inference engine; and
prioritize processing of remaining requests of the plurality of requests for which processing has been delayed by more than a predefined period to mitigate requests having a large processing latency.

20. A non-transitory computer-readable storage medium, the computer-readable storage medium including instructions that when executed by a computer, cause the computer to:
receive, at a generative response system, a plurality of requests to generate responses based on respective fine-tuned models;
organize the plurality of requests into first requests and second requests based on which requests of the plurality of requests use currently-loaded fine-tuned models that are on one or more inference engines of the generative response system when the plurality of requests are received, wherein the first requests use the currently-loaded fine-tuned models and the second requests do no use the currently-loaded fine-tuned models; and
process the first requests; and
process the second requests, after processing the first requests.
